(19) United States
(12) Patent Application Publication
(10) Pub. No.: US 2010/0144455 A1
(43) Pub. Date: Jun. 10, 2010

(54) Device and system for obtaining, analyzing, and displaying information related to a golfer's game play in real-time

(76) Inventor: Frank Ahern, Payson, AZ (US)

Correspondence Address: Law Office of ROBERT C. KLINGER, 2591 Dallas Parkway, Suite 300, FRISCO, TX, 75034, US

(21) Appl. No.: 12/653,088

(22) Filed: Dec. 8, 2009

Related U.S. Application Data
(63) Continuation-in-part of application No. 12/589,681, filed on Oct. 27, 2009.
Application No. 12/589,681 is a continuation-in-part of application No. 12/386,191, filed on Apr. 15, 2009.
Application No. 12/386,191 is a continuation-in-part of application No. 12/587,264, filed on Oct. 5, 2009.
Application No. 12/587,264 is a continuation-in-part of application No. 12/386,191, filed on Apr. 15, 2009.
(60) Provisional application No. 61/195,857, filed on Oct. 10, 2008.
(60) Provisional application No. 61/195,857, filed on Oct. 10, 2008.

(51) Int. Cl. A63B 69/36; G06F 19/00; A63B 57/00

(52) U.S. Cl. 473/222; 700/92

(57) ABSTRACT

The present invention achieves technical advantages as a device and system utilizable during actual golf game play configured to obtain information related to a player's golf swing and game performance. This information may include information generated by a sensor(s) located on or within a golf club or worn by the golfer, which information is configured to be sent to a golf appliance, such as a golf glove, an automatic scoring and game statistics apparatus worn by the golfer, or a remotely located monitoring/display unit. These sensors provide data to facilitate assessing a player's swing, to determine a ball strike, determine swing velocity, identify the club used, and other data usable during actual game play. An additional aspect of the invention provides for a golf glove appliance and club grip system for detecting correct hand position as the golfer grips the club during a swing.

### CLAIM OF PRIORITY

The present application is a continuation-in-part of U.S. patent application Ser. No. 12/589,681 filed Oct. 27, 2009 entitled “GOLF CLUBS PROVIDING FOR REAL-TIME COLLECTION, CORRELATION, AND ANALYSIS OF DATA OBTAINED DURING ACTUAL GOLF GAMING, which is continuation-in-part of U.S. patent application Ser. No. 12/386,191 filed Apr. 15, 2009, entitled “AUTOMATIC REAL-TIME GAME SCORING DEVICE AND GOLF SWING ANALYZER”, which claims priority of U.S. Provisional Application Ser. No. 61/195,857 filed Oct. 10, 2008 entitled “GOLF SWINGER”, and is also a continuation-in-part of U.S. patent application Ser. No. 12/587,264 filed Oct. 5, 2009 entitled “A GOLF AND GRIP PROVIDING FOR POWER AND CLUB SENSOR PARAMETRICS SIGNAL TRANSFER OBTAINED IN REAL-TIME”, which is continuation-in-part of U.S. patent application Ser. No. 12/386,191 filed Apr. 15, 2009, entitled “AUTOMATIC REAL-TIME GAME SCORING DEVICE AND GOLF SWING ANALYZER”, which claims priority of U.S. Provisional Application Ser. No. 61/195,857 filed Oct. 10, 2008 entitled “GOLF SWINGER”, the teachings of which are incorporated herein by reference.

### FIELD OF THE INVENTION

The present invention is generally directed to golf club devices, and more particularly to game performance tracking and swing analysis.

### BACKGROUND OF THE INVENTION

The game of golf is complex given the numerous elements that affect a golf shot. The basic physical properties include the properties of the golf club, the ball, as well as the ball lie and weather conditions. The more complex aspects involve the golf swing and the ball strike, which are the subject of detail analysis by golf instructors, as well as equipment designed to analysis a club swing.

Due to the aforementioned complexities even the simple act of accurately detecting a golf shot allowing for automatic scoring has not been reliably achieved, therefore, to this day a round has required manual input from the golfer. Such a requirement often leads to inaccurate scoring, distraction from the game, and loss of enjoyment.

An important aspect in improving one's game of golf is a need to be able to review the cause-and-effect relationships that result during each and every swing. Again considering the complexities mentioned above this can only be done accurately during actual play. The basic factors of such an analysis may be the club used, the distance the ball traveled, the effects the swing had on the ball travel (such hook or slice), and the hole/golf course in which these results occurred. This cause-and-effect relationship ultimately is the result of the golfer's club speed, swing profile, body/head positions and other parameters throughout the swing.

While some of the swing analysis methods utilized by Renee Russo in the movie Tin Cup may not possess practical value, more complex devices utilized to ascertain/estimate swing parameters during practice can be found at local golf instruction centers. However, these complex swing analyzers are not suitable for use during golf play on an actual course. Moreover, these analyzers do not provide statistics of an actual golf shot during play, and as a function of real world conditions.

### SUMMARY

The present invention achieves technical advantages as a device and system utilizable during actual golf game play configured to obtain information related to a player's golf swing and game performance. This information may include information generated by a sensor(s) located on or within a golf club or worn by the golfer, which information is configured to be sent to a golf appliance, such as a golf glove, an automatic scoring and game statistics apparatus worn by the golfer, or a remotely located monitoring/display unit. These sensors provide data to facilitate assessing a player's swing, to determine a ball strike, determine swing velocity, identify the club used, and other data usable during actual game play. An additional aspect of the invention provides for a golf glove appliance and club grip system for detecting correct hand position as the golfer grips the club during a swing.

### BRIEF DESCRIPTION OF THE DRAWINGS

FIG. 1 is a perspective view of a typical golf club showing one placement of a golf scoring system swing detector and/or club identifier, facilitating detecting an actual golf ball strike during actual play, and analysis of club swing profiles during actual game play as discussed throughout the various embodiments;

FIGS. 2A, 2B, 2C shows multiple locations of swing detectors and/or club identifiers that may be golf club mounted;

FIG. 3 shows multiple locations a scoring system receiver, and/or scoring system display units that may be worn on the golfer or mounted on a golf cart;

FIG. 4 is a block diagram of one embodiment of a club mounted swing detector;

FIG. 5 is a block diagram of a second embodiment for a club mounted swing detector;

FIG. 6 shows a block diagram of one embodiment of the automatic scoring gaming device;

FIG. 7 shows a block diagram of another embodiment of the automatic scoring gaming device;

FIG. 8 shows representations of a golf glove, and a golf club grip, wherein data information transfer occurs through physical proximity or contact, and a showing how power may be supplied to devices resident with-in the golf club;

FIG. 9 is a flow diagram of the automated scoring system according to one embodiment of the invention;

FIG. 10-12 are visual renditions of displays that may created by scoring devices according to one embodiment;

FIGS. 13A, 13B, 13C, 14A, 14B, and 14C depict the various club positions during a typical golf swing, with various locations of additional sensors providing real-time feedback of the various body positions effecting the outcome of a shot;

FIG. 15A is a block diagram depicting various embodiments that may be used to transfer/couple power between a swing detector, such as 200 or 400, and a unit such as 500 or 600;

FIGS. 15B, 15C, 15D and 15E depict different methods of direct and proximal power coupling shown in FIG. 15A;

FIGS. 16A and 16B show a representation of a golfer's hand and the proper way of gripping a golf club;

FIG. 17A shows a perspective view of a golf glove depicting how the glove finger tips map to corresponding portions of the club grip, FIG. 17B shows the golf glove with portions below the fingers of the glove corresponding to portions of the club grip;

FIG. 18A depicts the golf glove of FIGS. 17A and 17B shown open, palm facing up, where physical zones with electrical contacts on the glove are configured to transfer power and/or information through physical proximity or physical contact with the golf club grip;

FIG. 18B shows another embodiment of the golf glove with alternate arrangements of the physical zones having electrical contact points configured to communicate power and/or data signals with a golf club grip;

FIG. 19A depicts a golf club grip shown removed from a club and laid flat, the physical zones including the electrical contact point(s) on the grip configured to transfer power and information through physical proximity or contact with the club grip when properly held, which zones map to the contact points of the glove of FIGS. 17A, 17B, 18A, and 18B are indicated;

FIGS. 19B and 19C show alternate representations of club grips used to enable various embodiments of this invention;

FIG. 20 shows possible locations that may be used for the sensor, processor, power, or antenna placement within a golf club;

FIG. 21 shows a flexible circuit that may be embedded into or under a club grip, which facilitates the transfer of power and/or signals between a corresponding golf appliance(s) and sensor(s) contained on this circuit, within the golf club, or sensor(s) mounted on the club;

FIG. 22A shows a module inserted into a club at the top of the grip and also shows how it may directly couple to the grip;

FIGS. 22B, and 22C show how a club mounted sensor may be advantageously configured for power, or battery access;

FIG. 22D shows how an antenna may be part of a sensor module providing for better signal strength;

FIG. 23 shows embodiments in which power and/or signal interface coupling, or sensors, may be placed within or under the grip itself; and

FIG. 24 depicts the signal/data interface as a wireless interface, such as by RF and RFID.

Table 1 is a tabular representation of some of profiles used to enable the various embodiments, and the devices that may be used to enable the time/cause/effect detection and profiling;

Table 2 is tabular representation of some of the various device embodiments enabled by this invention, showing their capabilities and interactions between the various additional devices utilized in each embodiment; and

Table 3 is a tabular representation of some of the methods disclosed in the various embodiments with a brief description of each.

### DETAILED DESCRIPTION OF PREFERRED EMBODIMENTS

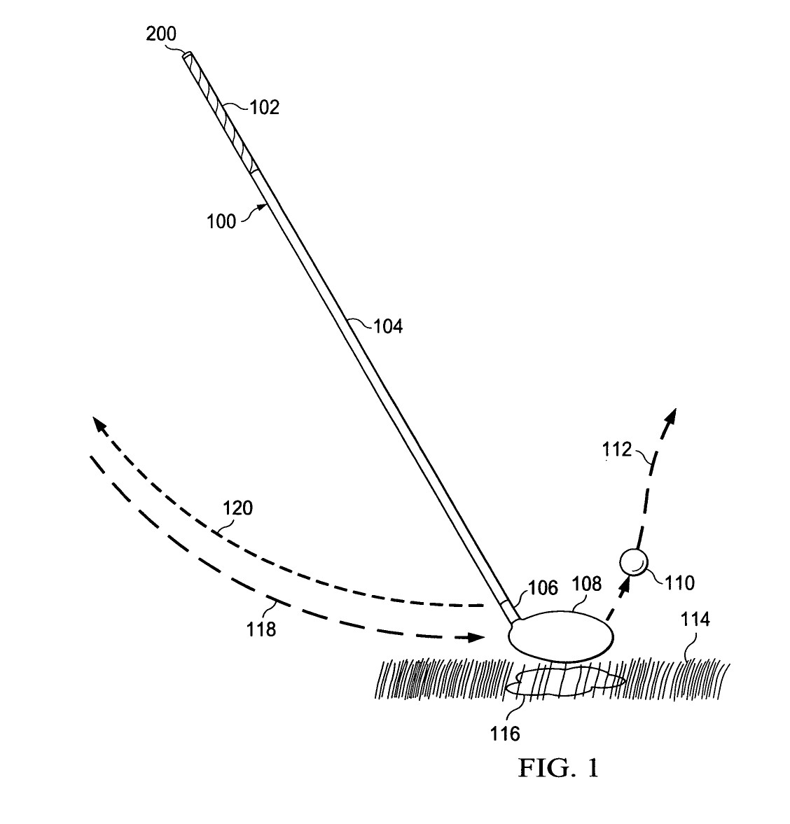

Referring to FIG. 1 a typical golf club 100 is represented. Shown also in FIG. 1 is the addition of a device that may include a swing detector 200 attached to golf club 100, shown in this embodiment at the top of the club's grip 102 in one preferred embodiment of the invention. The detector 200 is configured to detect an actual golf shot event, such as detecting the shaft 104's motion and/or vibrations, such as a resonant frequency indicative of a ball strike or a jolt, or a sound indicative of an actual ball strike during golf play. The detector 200 may include an accelerometer and or other sensor elements configured to detect an actual golf swing and/or ball strike. The detector may be located at another location on or in the club, or integrated with the grip as desired. The detector 200 is configured to generate a signal indicative of an actual ball strike during the actual play of golf.

FIG. 1 also shows for illustration a ball 110 that may have a path 112 when struck by the club, a playing surface 114, a divot 116, a club head swing path 118, and a club head backswing path 120.

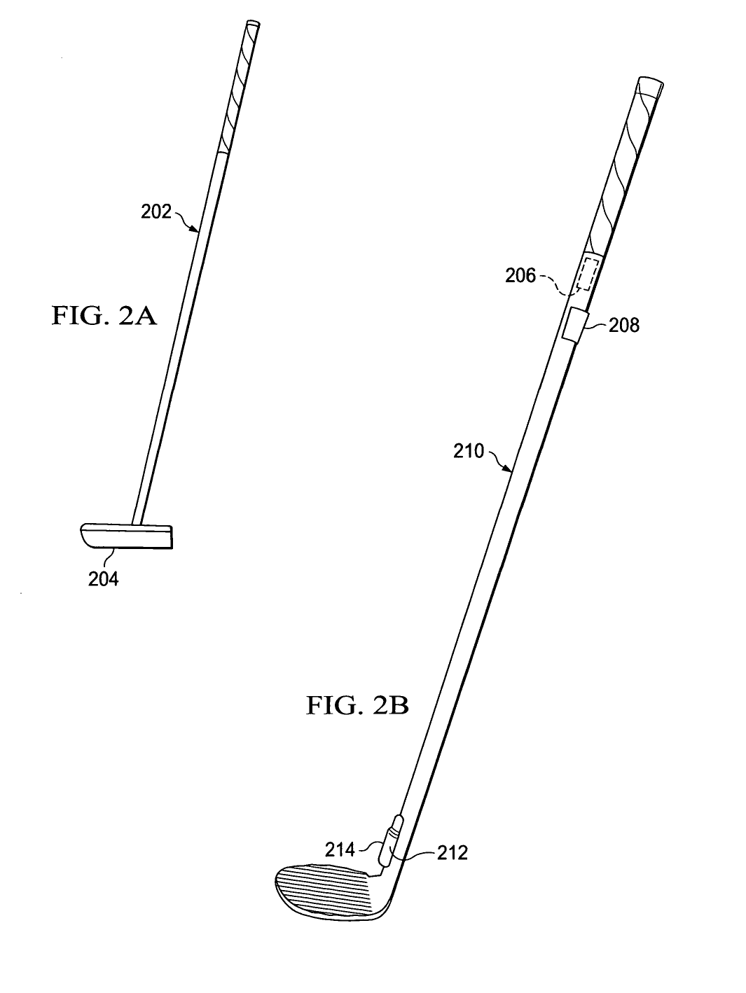

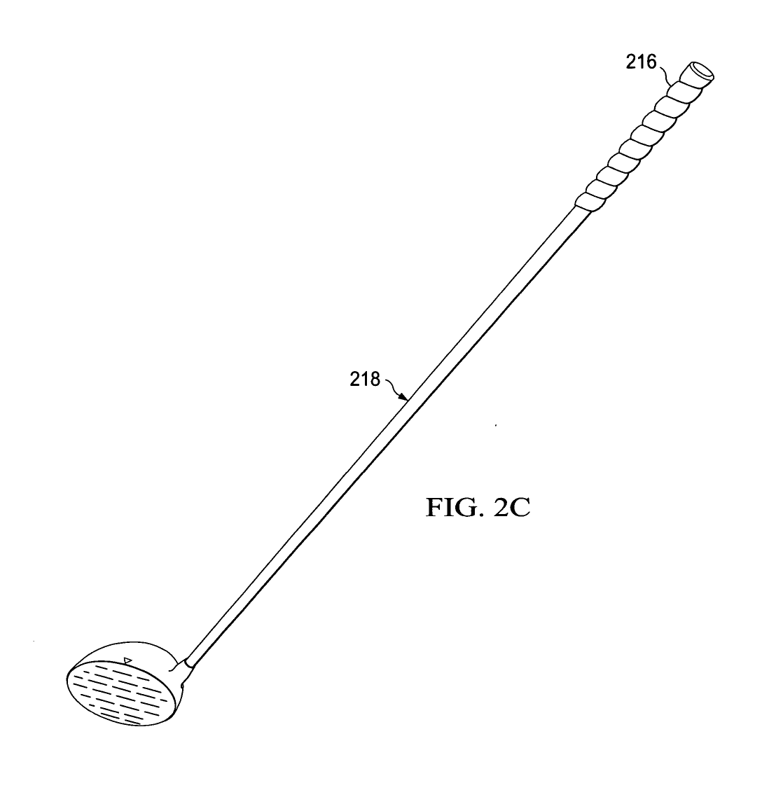

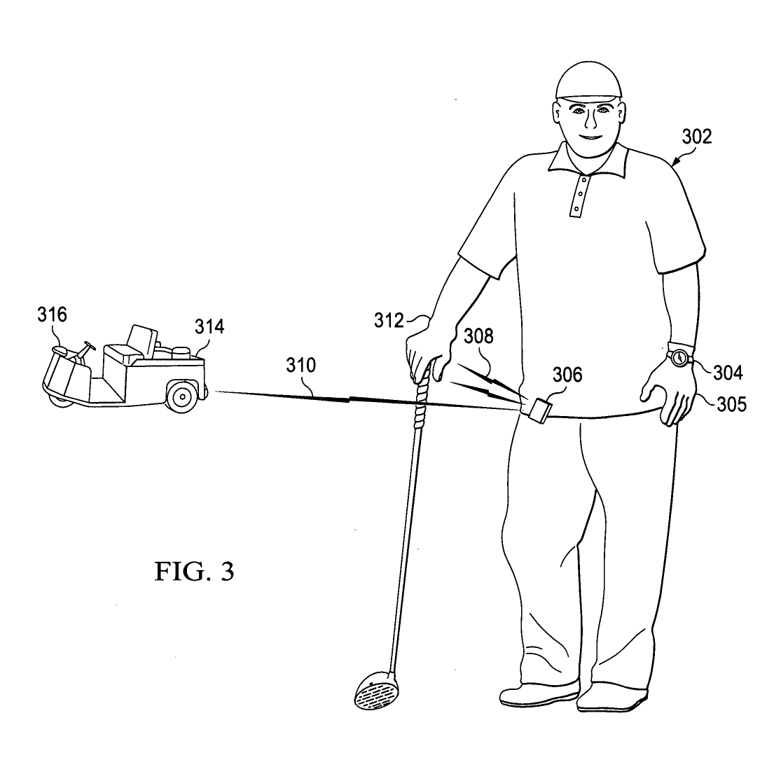

Shown in FIG. 2 are multiple detectors 200, one for each club, each configured to sense an actual swing and/or golf ball strike for the specific type of club, whether it be a driver 218, iron 210, or putter 202, that are each club mounted. Each detector 200 shown is configured to transmit data indicative of a golf ball strike, and/or golf swing characteristics, back to a reading/processing device 306 via link 308, such as display/scoring unit 600, which may be worn by golfer 302, or via link 310 to a remotely located device, such as in a golf cart 314 as shown at 316 in FIG. 3. The data transmitted may be responsive to a signal generated by unit 500, or may be automatically sent without prompting.

In various other preferred embodiments, different points of attachment of the detector 200 may be used, such as next to the club grip and directly onto a club shaft at 208, or within the club shaft itself at 206. The detector can also be mounted near a club head at 204 and 214, such as the club hosel, or internal to the club near point shown at 212. Although FIG. 2 shows different points of attachment on the three clubs represented, the specific points shown may be used on any of the clubs.

During a club swing, the golfer performs a slow backswing of golf club 100 in the direction indicated by 120. At the pinnacle of this action the direction is reversed and with the aid of the body movements the club head is accelerated in the direction indicated by 118. During this action different results may occur. The golf ball 110 may be struck directly, or the ground 114 may be lightly stuck before hitting golf ball 110. Other results such as the ground 114 being stuck in a manner that results in a divot removed at 116 may occur, after which the golf ball 110 may or may not be hit by the club head 108. Additionally, it is conceivable that the golf ball 110 is missed completely by the club head 108.

Regardless of which of the above actions takes place, the club head 108 will continue in some manner in the direction indicated by 112. Due to the amount of variables in the actions resulting from a golf club swing, the speed of a club head, and the similarity from one swing to the next, it is desirable for an automatic golf scorer that is capable of detecting and/or analyzing these variables to provide practical information as well as one that is portable, enabling its use during actual play.

While various approaches may be employed to detect the contact of a golf ball 110 and club head 108, they may be intrusive. Any device mounted or adhered to the face of club head 108 may affect features that are designed into the head to aid in spin and momentum transfer to the golf ball.

Other devices/sensors may mount at an area of the club likely to provide the greatest amount of feedback to a detection device, such as at point 214. Mounting a device in that location may affect the actual swing characteristics of the club itself, potentially altering the swing weight or resistance to the air, or just the fact that the golfer may perceive that such an affect occurs.

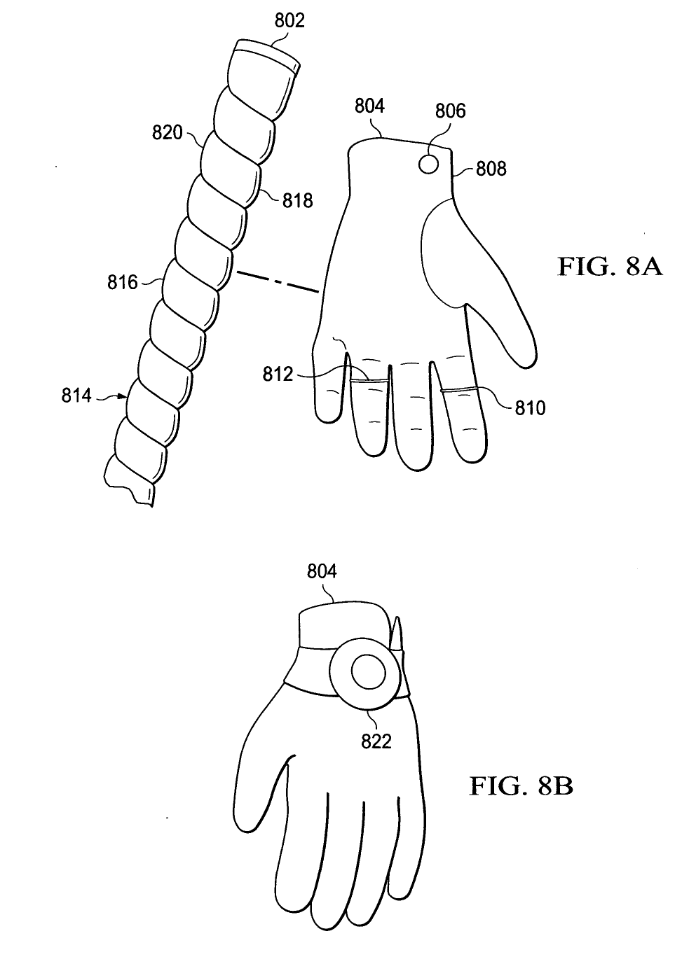

In yet another preferred embodiment, referring to FIG. 3, the detector 200 may be incorporated into/onto a glove of golfer 302 as shown at 305 and described later in reference to 806 and 822 shown in FIG. 8, wrist mounted in a player attachment/accessory 312, or incorporated into a watch 304.

In embodiments where the swing detector 200 is not physically attached to the club, the detector is configured to sense parameters indicative of the club swing and/or an actual ball strike. In a preferred embodiment each club has an ascertainable indicator that is indicative of the club. Identification may be made by reading an RFID code, by sensing a resistance indicative of the club, or some other method.

RFID tags may be designed in many physical configurations. For the above embodiments described wherein the swing detectors are not physically attached to each club, a properly shaped RFID device may be utilized in some of the locations previously discussed with swing detector 200. For example, a small circular RFID tag may be attached at 216, shown in FIG. 2C, or a larger rectangular one may be placed under or near a golf club grip such as at 206.

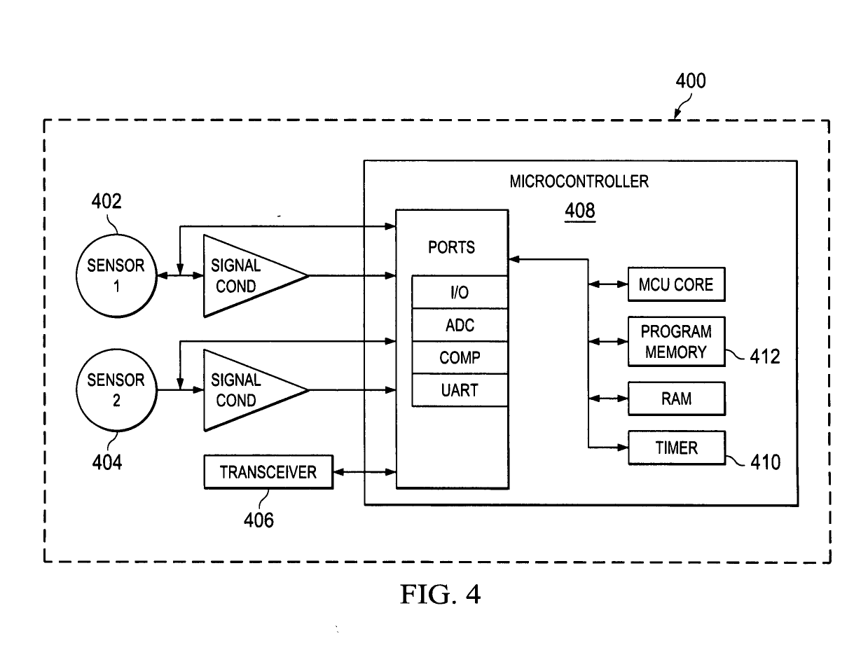

One embodiment of detector 200 is shown as detector 400 in FIG. 4. This detector 400 may be detachably mounted to clubs. This detector may also be selectively changed from club to club if desired. Shown in FIG. 2 is this detector mounted at 216 onto a driver 218, and at 208 mounted onto an iron 210. Other locations for this embodiment can be at 204 and 214. The detector 400 has a processor, such as a microprocessor, as well as supporting elements including memory and a data interface.

Detector 400 may also be mounted internally at points such as 206 and 212 shown in FIG. 2B on iron 210. It is contemplated that similar mountings and variations may also be used on putter 202 and driver 218.

Dependant on the preferred embodiment, the present invention advantageously detects both the club swing and actual ball hit. Additionally, it differentiates the actions that result in the incrementing of a stroke to the score, from those actions that do not, such as practice swings and divots.

As seen in FIG. 4, one embodiment of detector 200 is shown as detector 400 and may be attached directly to each club. Detector 400 includes a microprocessor 408, such as a Microchip technologies 12F683 or 16F883 configured to evaluate inputs from sensors 1 and 2 (402 and 404, respectfully), where such sensors may be accelerometers detecting positive and negative swing accelerations, and/or club angles, club vibration (such as a vibration frequency), or a step function delta indicative of a ball strike. One of the sensors may be used to provide additional feedback, such as a sound profile of the ball hit itself, or visual or sonic feedback of the golf ball itself.

Also shown in FIG. 4 is a timer 410, wherein the input signals received from the sensors and the timer are analyzed by processor 408 and compared to characteristic profiles stored in memory 412 indicative of many different types of events that may occur. For instance, the time between the initiation of a back swing until a ball strike can be correlated with other input, such as a club type, to determine actual club swing parameters. These club swing parameters are then transmitted back to unit 500 where additional analysis may be performed in real time, or at a later time, such as when the data is downloaded to a PC for later analysis. Transceiver 406 may be part of processor 408 or separate. Transceiver 406 is a low power short range device with a specific identification code and may be of the RF type, Bluetooth, or another transmission method.

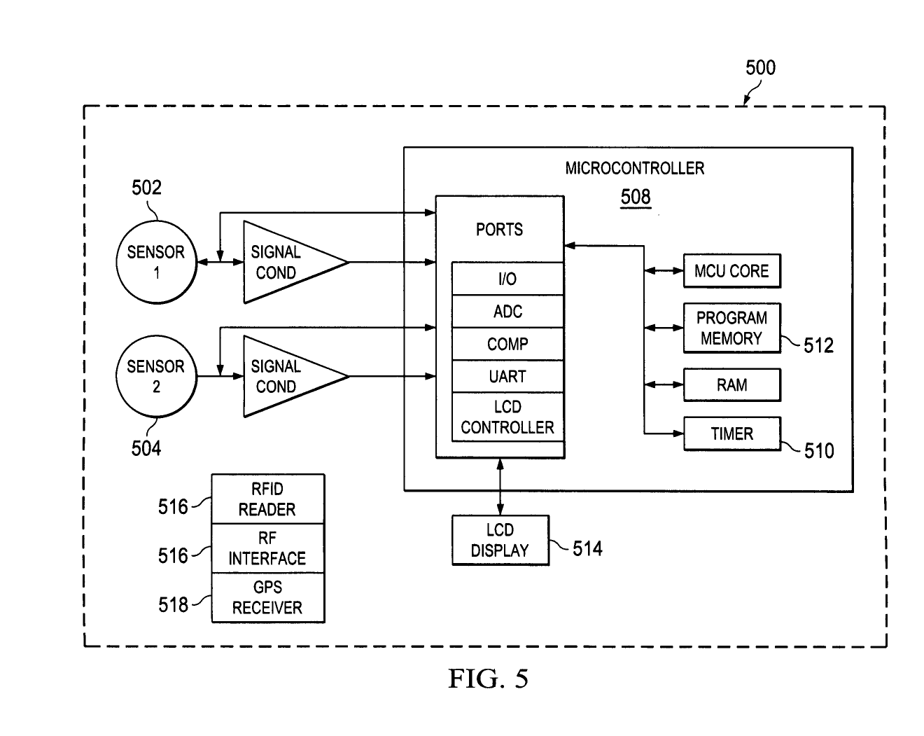

FIG. 5 is a block diagram of another embodiment of swing detector 200 shown as detector 500. Microprocessor 508, timer 510, sensors 1 and 2 labeled 502 and 504, respectfully, memory 512, and transmitter 506 may be utilized as described above for detector 400, or in a different configuration. This embodiment is configured to be worn by the golfer as shown in FIG. 3 as 304, 305, or 312. The detector 500 may also have a display 514 shown as 304 configured to generate a visual event indicative of the swing or ball strike. Moreover, the detector 500 may include an RFID interface 516 configured to receive RFID signals from a club, such as indicative of the club used during a swing and ball strike. Aside from an RFID device, an alternative method may be used for identifying each club, such as a resistance discrimination method, wherein each club has a unique resistance characteristic such as in the grip, detectable by golf glove 804 and shown worn by golfer 302 as 305. Additionally, other club identification means could be employed as recognizable by those skilled in the art.

Detector 500 may also include a low power short range device with a specific identification code and may be of the RF type, Bluetooth, or another transmission method to communicate information to a display/scoring unit, such as unit 600 or unit 700, as similarly done in device 400, shown here as an RF interface or wireless interface 516. A GPS receiver 518 may also be incorporated or the transceiver means used to communicate with a separate GPS device.

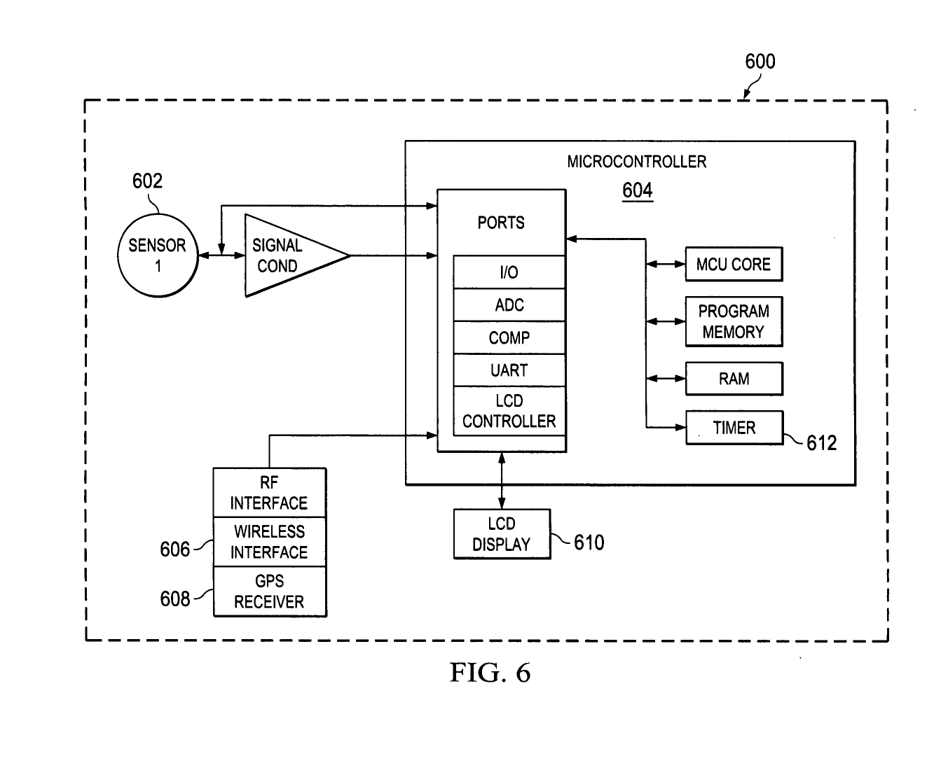

FIG. 6 is a block diagram of the user worn display/scoring unit 600. This unit partially consists of a microprocessor 604 such as a Microchip Technologies 18F6393, timer 612, and micro display 610. Information/data is received by transceiver 606 from a single club, or even multiple clubs, with embedded detectors. For the embodiments where the clubs do not have these detectors, information may be received from body mounted swing detectors, such as those shown in FIG. 3 at locations 304, 305, or 312. Additionally, a physical contact glove detector may be used as described later in an additional embodiment. The unit 600 receives the data from the user worn glove transceiver/detector, such as that shown in FIG. 8A and FIG. 8B at location 806 or 822. Due to the many embodiments it is important to understand that a user worn display/scoring unit such as that shown as 304 in FIG. 3 may also incorporate a swing detector, therefore, similarities as well as differences are explained in both the descriptions of units 500 and 600.

Algorithms in processor 604's embedded code perform additional analysis on this information/data. One preferred embodiment incorporates a GPS receiver 608, while another embodiment having at least one sensor 602 determines game scoring by using and/or correlating the profiles and methods outlined in Tables 1 to 3. For example, the length of time between golf club swings, which club was last used, the changing of a club, and vibration data, such as a traveling profile described in Table 3. This data and the method algorithms may be used to determine that one hole is completed and a new hole is being approached and adjust the stroke count appropriately.

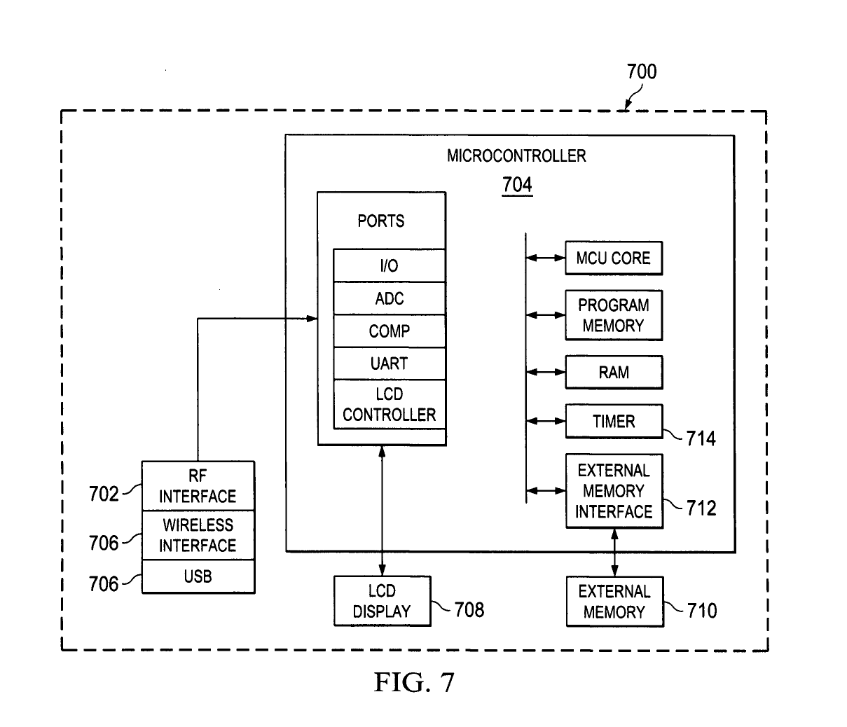

FIG. 7 is a block diagram of the cart display/scoring unit 700 having at least one system including wireless interfacing, such as an RF interface 702, and may have additional data communication means 706 such as, but not limited to, Bluetooth, Wireless Internet, Cellular, or USB. This unit partially consists of a microprocessor 704 and timer 714 and display 708. Information/data is received by a transceiver/wireless interface 702 in real time from body mounted swing detectors, such as those shown in FIG. 3 at locations 304, 306, or 312.

Transceiver 702 communicates with the multiple swing devices 200 while transceivers 702 and/or 706, additionally, may be configured to receive code and profile updates, or download the results stored in unit 306 and 316 to a PC or other devices such as a PDA, in real time via a data link, or at a later user defined time. Using transceivers in place of transmitters allows for additional functionality. For example, the individual profiles and sensor characteristics can be updated, or swing device data communication could initiated by request or polling, such as initiated by remote display/scoring unit 306 or 316. Such improvements may result in longer life to batteries in sensor 200, not shown in these diagrams.

FIG. 7 also shows an embodiment where additional memory may be included. This memory can be interfaced to directly from an integrated memory controller 710 contained within a microcontroller, such as a Microchip technology PIC 18F8493. An advantage of this embodiment is that wireless data may be communicated amongst other teams such as in a tournament play. Additional memory also allows multiple players to have ready access to a great amount of historical play information previously obtained by the automatic analysis system being described herein. An instance of such data may be a data screen selection displaying information on selecting your golf club based on an analysis of the distance required and the average distance hit with various clubs that day and/or historically. An additional use may be to select a screen display that provides recommended changes to your golf swing based on how you are hitting the ball that particular day (e.g. you are slicing to the right, please try to do . . . , your acceleration is too slow, try picking up golf speed, etc.)

Advantageously, the display/scoring units described herein as units 304,306, 316, 600, and 700, release the user of the burden or trying to remember a lot of details during game play, but can rather rely on the data now immediately available to make adjustments to one's game play during the game. Frustration is reduced because a golfer does not have to wait until the next game to consider how to improve one's game. By knowing that one is hitting the 7 iron well, for instance, one may choose that club over a 6 iron if one knows that he/she is hitting it better.

As shown in FIGS. 8A and 8B, the user worn glove includes a detector 806 or 822 configured to read/ascertain data indicative of the club used, and transmit or render available, this data to a remote device such as unit 306 or 316, or any other data unit as desired. The advantage of this embodiment is that an active sensor or passive sensor can be placed on or within the club, which may be cheaper. This embodiment may not include an accelerometer, and may simply just count shots on each hole and the total for the round, or may also provide useful data during actual game play for consideration by the golfer prior to the next shot, or set of shots.

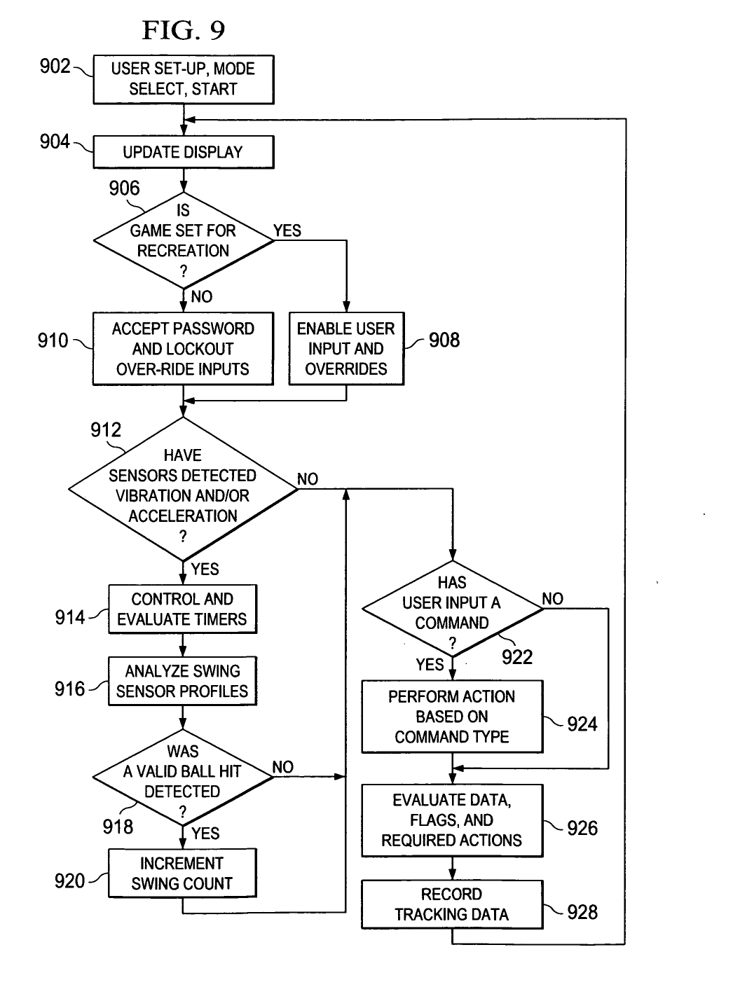

FIG. 9 is a flow diagram of the processing steps that may taken by the display/scoring unit 306 and 316 in conjunction with a single swing detector of type 200, during a normal round of golf. As shown at step 902 the system is initialized, set to the desired mode, and started.

When the scoring unit resets during power-up, or is reset by a player, it remains in a standby state awaiting a user's input. Internal flags are initialized and sensor inputs are disabled until a player initiates the start of a game. The player may select a game, or to download stored information to a PDA, or other additional functionality. The display is updated at 904 and the player is queried as to the type of mode desired. During recreational games 906, the user is allowed to modify the stoke count determined by the automatic scoring system 908. Other rounds, such as those during a high school competition, could be set to lock out any user input that affects the score 910. Additionally, this data may be broadcast in real time, or delayed, to a central location, such as a server, to obtain and display multiple player data for analysis or review.

In one embodiment unit 306 or 316 will now wait for input from a swing device 200. Upon receiving input from the device, the state flow for the display/scoring by-passes step 912 and continues to 922. When sensor device 200 detects motion at step 912, the processor evaluates and performs data storage and calculations at step 914. When a valid profile that affects unit 306 or 316 is detected this information is transmitted to it. If the transmitted information and the data within unit 306 or 316 determine that a shot was taken at step 918, the shot count is incremented at 920.

Step 922 looks to see if a user input has occurred. The actions that may result from an input are determined at step 924. If the mode is recreational the score can be adjusted. In all cases a user can flag an event for analysis, of the processed data, at a later time. For example, if a player did not agree with the scoring of a hole he could flag that hole. The inputs to, and the decisions made by the swing counter, as well as the scoring unit could later be reviewed.

The scoring display unit 306 and 316 as well as the swing device 200 will continually be re-establishing a new current state and determining how it may affect the next action. This occurs at step 926. Finally, all raw data is stored during step 928 and the process continues.

It is important to remember that the real time loop presented in this flow diagram occurs repeatedly at microprocessor speeds. The states shown on this diagram are simplified to facilitate the explanation and teaching of this invention. It will be recognized by one skilled in the art that methods and process steps can be altered to occur in a different order or even simultaneously, such as an internal counter routine updating status variables or data calculations caused by timer interrupts to the processor.

A GPS receiver coupled to, or integrated with, the above swing detection system, such as the user worn display/scoring unit, further enhances the present invention by providing ball location and golf hole data correlated to the data obtained, such game play and swing analysis.

The GPS receiver gathers information from multiple satellites. With this information, the invention can accurately determine the receiver's location during golf play. The GPS receiver is designed to communicate with processing devices in a NMEA2.1 or similar protocol. Information about the receiver's longitude, latitude, altitude, and time aid the invention in providing the golfer the ultimate of real time and post play analysis.

When the GPS unit is utilized in one preferred embodiment, the cause-and-effect relationship of a golf shot, swing profile, club, course, and other conditions can clearly be correlated, tracked and presented in a graphical and easy to interpret display, in real time in units 500 and 600, or stored for post game analysis.

Graphical interfaces, and even animated interfaces, prove to surpass the learning traditionally obtained within a control facility, or environment, as well as greatly enhance the game enjoyment.

For an example, using the display device 306 or 316, or a remote PC/PDA with downloaded data there from, during post-analysis, a golfer can pull up information about a round that has been played. By zooming in, any particular hole may be selected, or a screen button can be clicked. The player can choose other options to learn about prior performance on a given course or hole, and can add notes. Data can also be shared between users of various automatic scoring systems equipped with a wireless interface such as that shown in device 600, or even uploaded to other sites, such as via the internet for further analysis, scoring and processing.

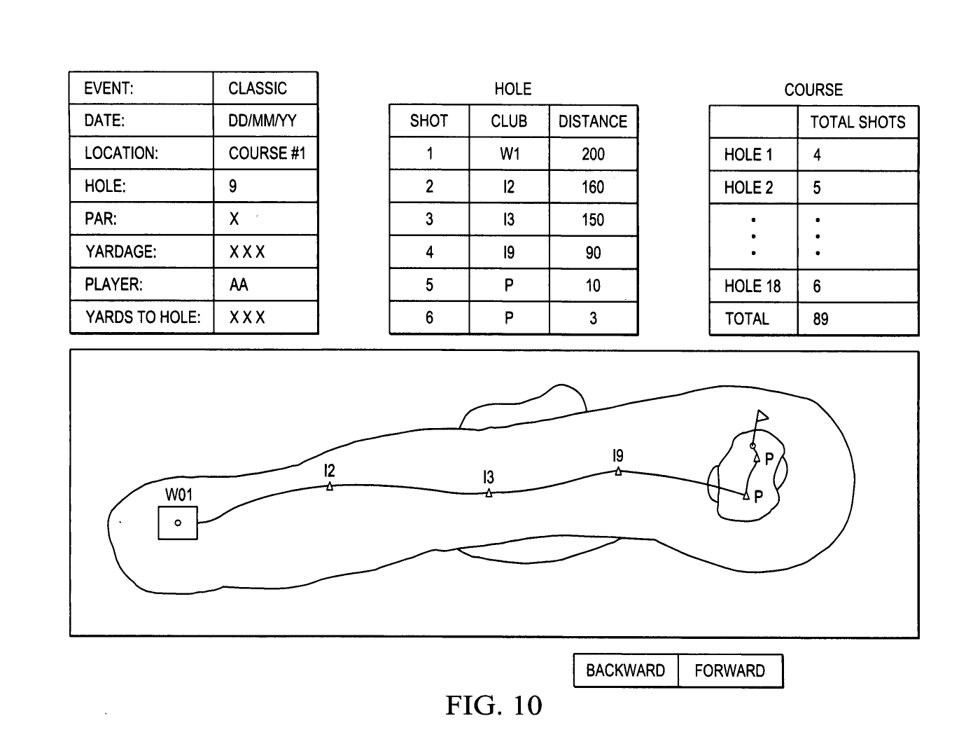

Now looking at FIGS. 10A and 10B there is shown one display that may be visually rendered by unit 306 or 316 during play. Understanding that unit 306 may be an embodiment that only allows for alpha-numeric type information, such as that displayed on a micro-display, the information presented in FIG. 10A is representative; however, the displayed unit may be such as a PDA. In such a case the information is presented both in FIG. 10A and FIG. 10B may be displayed. The visual display may include actual game specific information, including shots taken, club used, distance of each shot, hole information, course information, date, and other statistics valuable to the golfer, in real time, during the actual play of the game. This information can be used by the golfer in determining one or more future shots on the same hole, or a future hole. The user can scroll backwards and forward between individual holes to consider play during the actual game. For instance, while playing hole 10, the user can scroll back to the display showing the play for hole 7 to ascertain the club and distance parameter and use this information to determine which club to play at a given location on hole 10. As a course is played more frequently additional information you need in completing a more detailed pictorial is obtained. By having this information a golfer can more easily visualize what a given hole that was played like. Hazards, doglegs, and other information may provide feedback and why a particular club which chosen and why the distance with this club may be significantly different than when this club was used on a different hole.

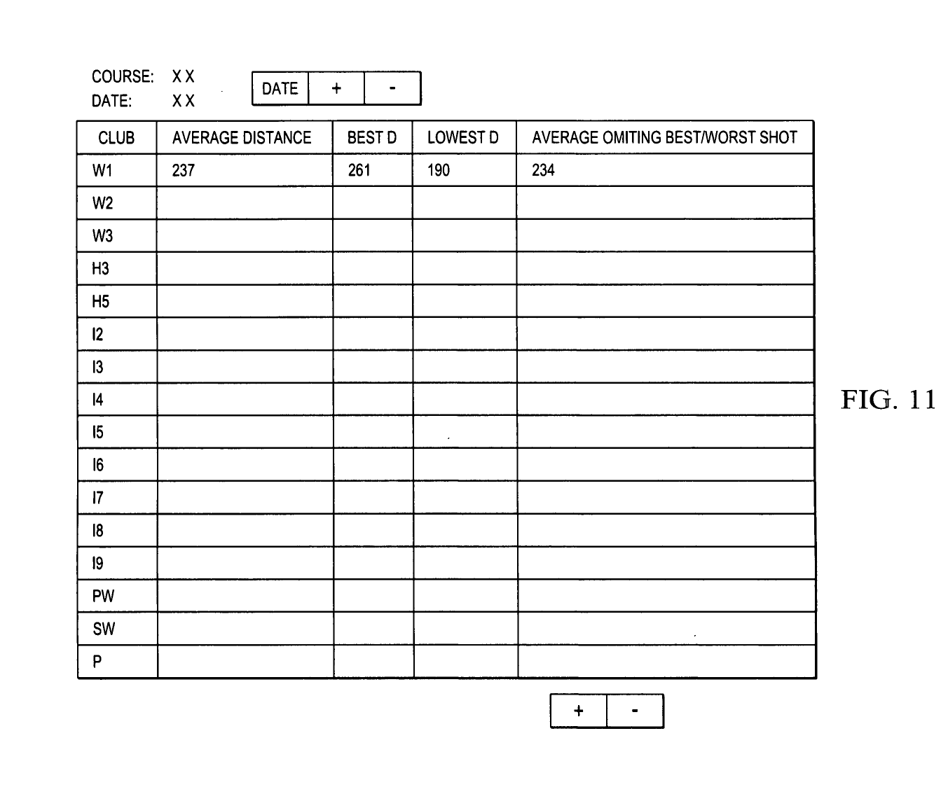

FIG. 11 shows a display in another format, which renders current game information, such as club performance/results during the current game. For instance, the player can appreciate the average distance of a shot as a function of the club. The results can even be weighted or selectively removed/edited so one can appreciate relevant information.

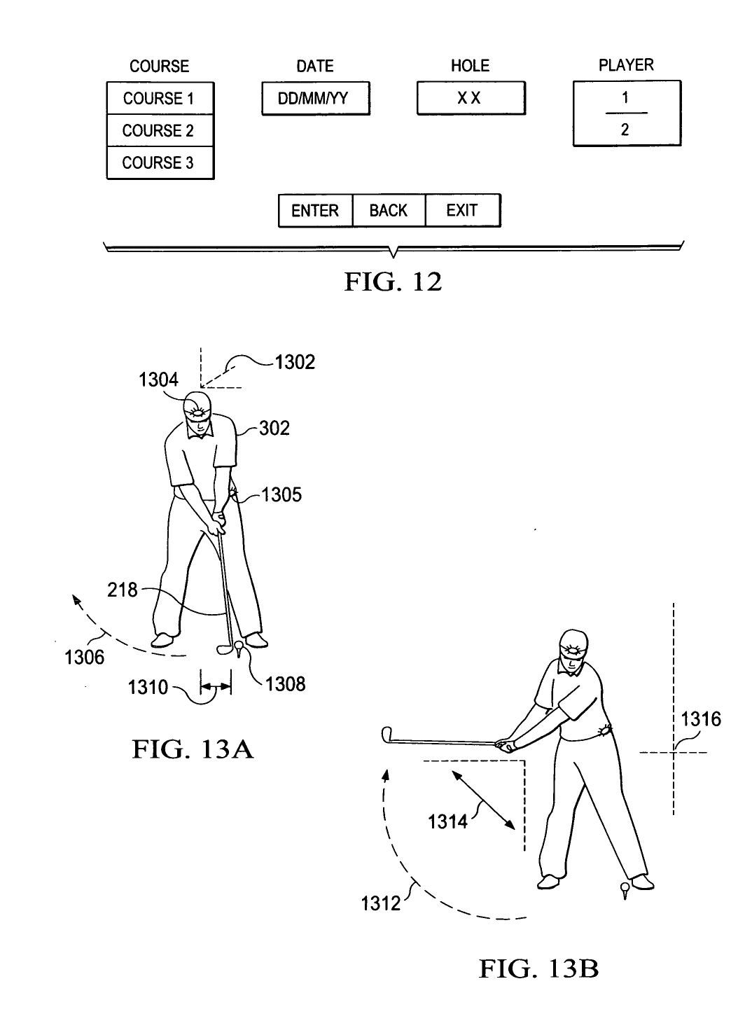

FIG. 12 shows a menu option so a golfer can, during game play, see and consider how he/she played the hole on a previous occasion. For instance, the player can select a desired course, the date played, and the hole played, and hit enter. The stored information for this entered data will then be displayed. Advantageously, the golfer can appreciate data from previous actual play on the same course or a different course, the same hole or a different hole.

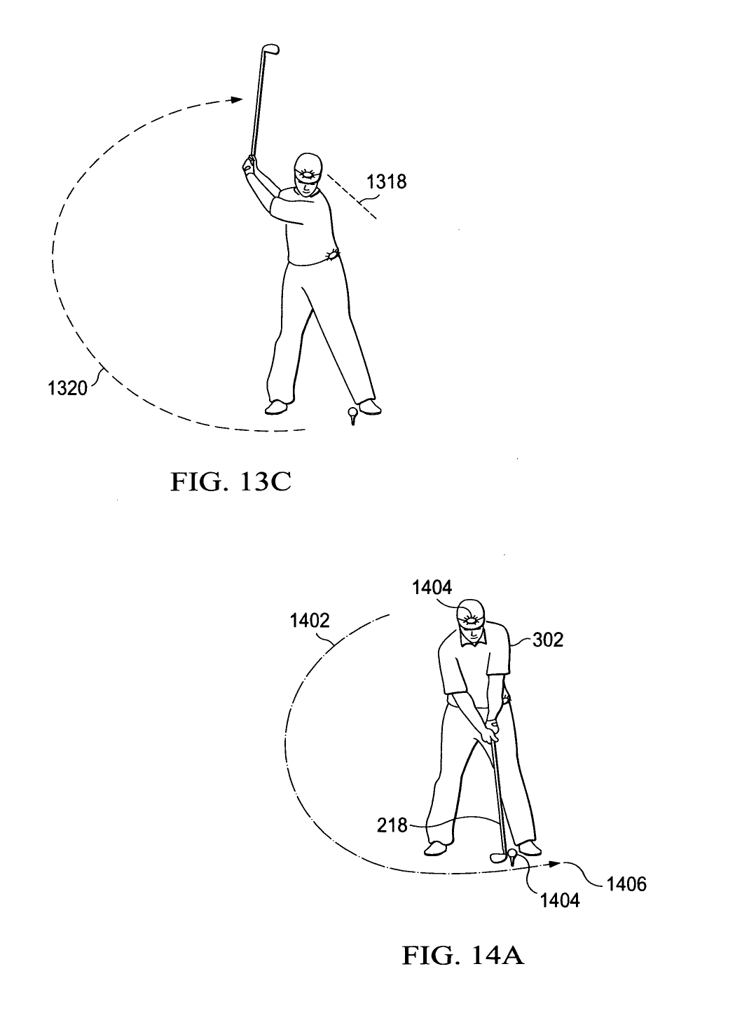

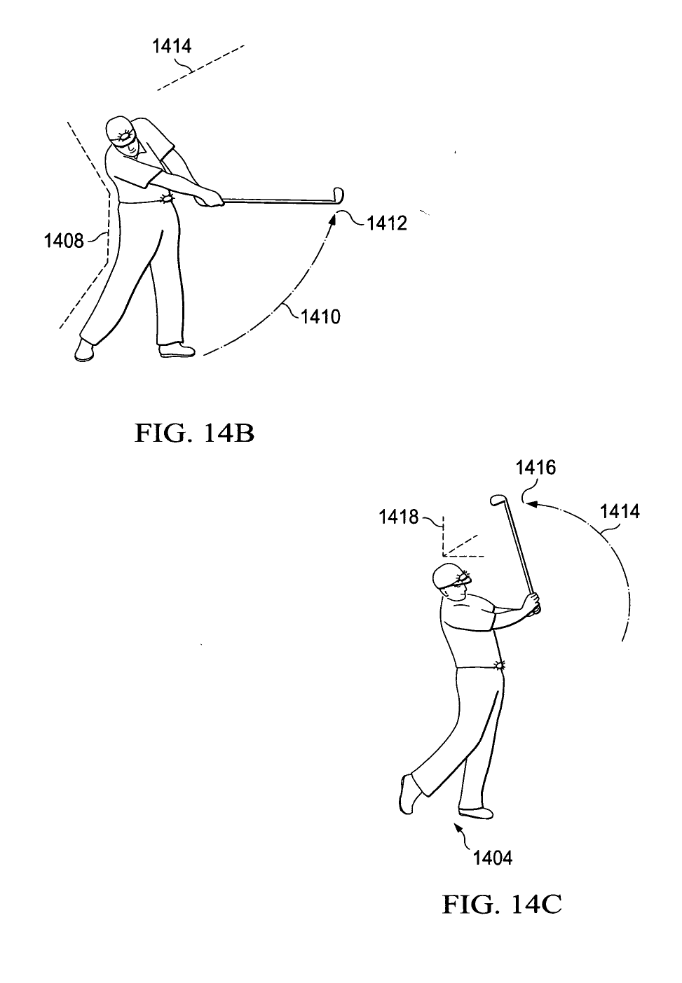

Now looking at FIGS. 13A, 13B, 13C, 14A, 14B, and 14C there is shown the various club and body positions that occur and can be detected and/or analyzed by detector 200 throughout the action of a typical golf swing. This is accomplished by a combination of analog and/or digital filtering, time profiling, and the effect of a shot as observed by the location of the ball's final landing place. Once again, referring to two distinctively different embodiments; that of utilizing a GPS receiver, and that of accomplishing similar informational data without the cost or benefit of a GPS receiver, these various embodiments are summarized in tables 1 to 3. To some, golf is a lifetime pursuit of perfection, while to others it is an afternoon in the sun. Therefore, much consideration has been given into how to teach multiple embodiments that reflect various market and product decisions.

Depending on the embodiment, an ordinary skilled engineer may incorporate one of several implementations presented here as well as others enlightened by these teachings.

Let us first look at the various events detected by the various embodiments disclosed:
A simple ball strike;
a practice swing versus a whiff;
a divot continuing into a ball strike;
a sand trap ball hit at the top.

While the simple ball hit may be basically shock detection, a more sophisticated algorithm is employed to distinguish this from the other above mentioned.

One may consider a swing profile analysis as a more complex action than the aforementioned, and this is not the case when implementing all of these features. A profile analysis of the swing essentially deals with the acceleration or velocity, depending on one's viewpoint of the swing. Also taken into account is the relative position of the club in the x,y,z planes throughout the profile.

Some of the desired information in swing analysis include but is not limited to
backswing velocity;
swing arc;
club swing acceleration;
club follow-through.

One should take note that the items mentioned here essentially are referring to the detection on the club or near the club, such as the golfer's wrist. Also, as clearly seen in FIGS. 13 and 14, the specifics of the golfer's body position are not clearly addressed by the sensors located in one or both of those regions.

An occasional recreational golfer may simply require the convenience of an automatic scoring device. Improving golfers are likely to be interested in correcting and consistently reproducing a correct swing profile.

Table 1 is a tabular summary of various profiles that are analyzed during a round of golf. These profiles are used to determine/correlate a relationship between the golfer, elapsed time, and input from the various sensors. With this information, according to one embodiment explained later on, the invention may simply keep automatic score of a golf round. When other sensors are utilized, the invention allows one to track, show or render the ability/actual play, advantageously providing more meaningful, detailed, real-time information about one's performance.

Table 2 shows various profiles described, such as backswing or RFID read. The profile used will be dependent on the embodiment being implemented. Depending on the implementation, as shown in Table 2, there is another way of looking at how to determine that a golf shot was taken.

Table 3 complements Table 2 in that it provides a brief description of the methods that are used with the various device combinations to achieve these profiles.

Again referring to FIGS. 13A, 13B, and 13C one can observe the various positions throughout a typical golf backswing. Shown in these figures is a typical golfer 302 performing a swing using driver 218. FIG. 13A shows a unit 200 configured to be worn on a hat or hatband with the detector located on the forehead. Additional sensors of this type may be worn in various other player locations such as on a belt to detect hip and body shifting throughout the swing. Sensors of this type may be attached in a multitude of means, such as but not limited to clip attachments, band attachment, and clothing with sensor integration.

Shown in FIG. 13 is a slight movement of golf club 218 at or near golf ball 1308, shown at location 1310. In table 3 this is a method described as club swing: aim alignment. The data is collected from swing detectors 200 located on or in golf club 218, and is coordinated with body worn detectors at locations 1304, 1305, and/or all the locations on which the golfer chooses to place them. This data may be used to analyze both the effects of the club swing profiles summarized in table 1 such as of club swing: aim alignment 1310, club swing: backswing 1306; as well as those effects introduced by the body movements themselves. Combined with time and analysis, the golfer is provided with information vital to identify the golfer's individual play characteristics and therefore rapidly aid in the improvement of his/her play. Examples of such information are backswing velocity, the lifting of one's head just prior to the shot, the body positional alignment in its relationship towards the flag and hole on the golf green.

In FIG. 13A the x,y,z positional coordinates shown at 1302 reflect those of the golfer's head throughout his swing, depicted in all FIGS. 13A through 14C. Of particular importance is the timing when a head position changes from viewing the golf ball at location 1310 to watching its flight at the time of the swing completion 1416 in FIG. 14C.

In FIGS. 13A to 13C, the total backswing path is represented in stages shown starting as 1306, continuing through 1312, and reaching its peak at 1320. The club angle change with respect to the vertical is shown as 1314, while the body potion shift is shown as 1316, and a final change in shoulder angle with respect to the horizontal ground plane at 1318.

As shown in FIG. 13 the effects on the flight of golf ball 1308 from the club swing profile are primarily sensed and analyzed from club mounted detector 200s during the path as shown by 1306, 1312, 1320. The body's influences are shown here as 1302, 1316, 1318. Without the benefit of time analysis and the benefit of the landing position of the ball, the instructional aid is diminished, while for a casual golfer this information may still be adequate.

FIGS. 14A to 14C show the forward swing continuation. Here distinct locations of the swing are called out such as the combination of 1402, followed by 1406; continuing 1410 to 1412, and 1414 to the completion of the swing at 1416. These points, as well as those that similarly occur within the swing paths shown in FIG. 13, indicate approximations of data collection times based on device 200 sensor input that is used during time/event profiling when a club is swung.

According to the various embodiments of this invention, this data can be obtained by the sensors 200 in real time.

Data Protocol Transfers

Dependant on the embodiment, either the display gaming device or the swing analyzer can initiate the start of data collection by the swing analyzer. The display gaming device may send a start request to the swing analyzer, and the swing analyzer then begins collecting data for analysis against desired profiles. When the swing analyzer determines that a profile has occurred, it transmits data back to the game display device.

Swing analyzer data transfer is both time and event tagged. Data logging is maintained in an efficient manner, so for example, if the golfer has taken practice swings but no ball hit was detected that data could be marked for over-write. In the swing analyzer, the RAM memory used to collect raw data is treated as a stack, wherein when the last memory location allocated for data storage is reached, the pointer is reset to the first location. If a protection flag is set it proceeds to the head of the next set of data.

Data transfer to the display unit may be either just specifically requested information, or a complete transfer of all raw data. Each time data is transferred via RF, power is consumed therefore transfers are kept minimal

In one embodiment, what is transferred is only the pertinent information. For instance, a ball hit has occurred in a mode selected to only keep score. In another embodiment, such as where analysis is performed, the pertinent sensor data is transferred with the time tag and the event tag. The analysis of this information is then correlated to one of the profiles discussed in table 1 to 3.

At times a request for all raw data may be made for later analysis. In such a case all of the time and event tags along with their sensor values are transferred. Collecting this amount of raw data requires an implementation using sufficient memory to allow for 18 or more holes.

One protocol transfer sequence may look like this:

Here, time is expressed in milliseconds while accelerometer x,y,z axis angle and acceleration are expressed as voltages.

| | | | | | | |
|---|---|---|---|---|---|---|
| Club ID/ | Time | Latitude | Longitude | X | Y | Z |
| Protect and | | | | axis | axis | axis |
| error flag | | | | accel | accel. | accel. |

| | | | | | | | |
|---|---|---|---|---|---|---|---|
| Event Tag/ | Time | X | X | Y axis | Y | Z | Z |
| Protect and | Delta | axis | axis | angle | axis | axis | axis |
| error flag | | angle | accel. | | accel. | angle | accel. |

Monolithic IC Accelerometers, such as an Analog Devices ATXL 330, can work in both static and dynamic acceleration modes. A static acceleration of gravity is used in tilt sensing applications. A dynamic acceleration is a result of motion, shock, or vibration. Accelerometers of these type may prove advantages in one preferred embodiment. As seen in FIG. 4, sensor input may be applied directly to a processor I/O, may be conditioned and then applied, or may be used as two inputs proving isolation to allow for different filtering to take place out of the same accelerometer.

Additionally, accelerometers are chosen as one to three axis allowing for different levels of maximum g's. A user selects the bandwidth of an accelerometer using external capacitors on each X, Y, or Z. axis. Depending on the model of accelerometer chosen each axis may differ in available bandwidth. For example, on a ATXL 330 device, the X and Y axis allow a range of 0.5 Hz to 1600 Hz, while the Z axis is limited to 0.5 Hz to 550 Hz. Conforming to:

F_{-3 db}=1/(2 pi(32k)×C_{(x,y,z)}

Additionally advantages for this device is its low power consumption and its ability to run from a single supply ranging from 1.8 V. to 3.6 V. to accomplish this the signal outputs are ratio metric. One must however be aware that while the output sensitivity varies proportionally to the supply voltage the output noise is absolute in volts. Or stated another way as the supply voltage increases the noise density decreases: rms Noise=Noise Density×(BW×1.6.)

While the low power consumption of these devices makes them ideal for this application, one must be sure to take into account these noise considerations due to the extremely low mV levels being dealt with during calculations.

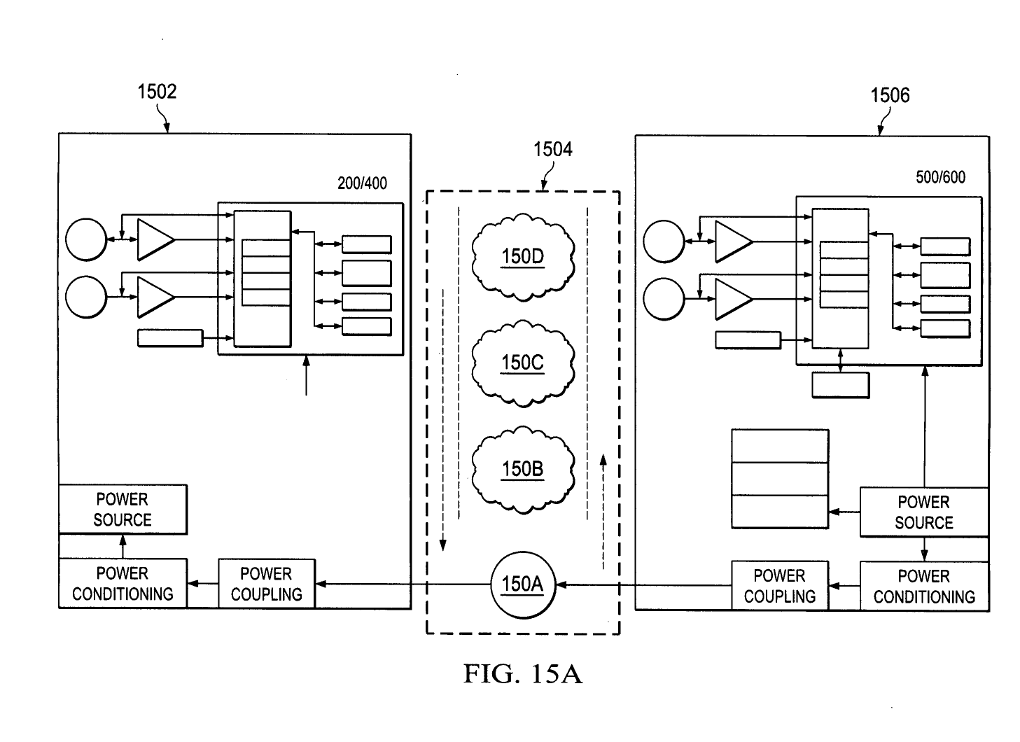

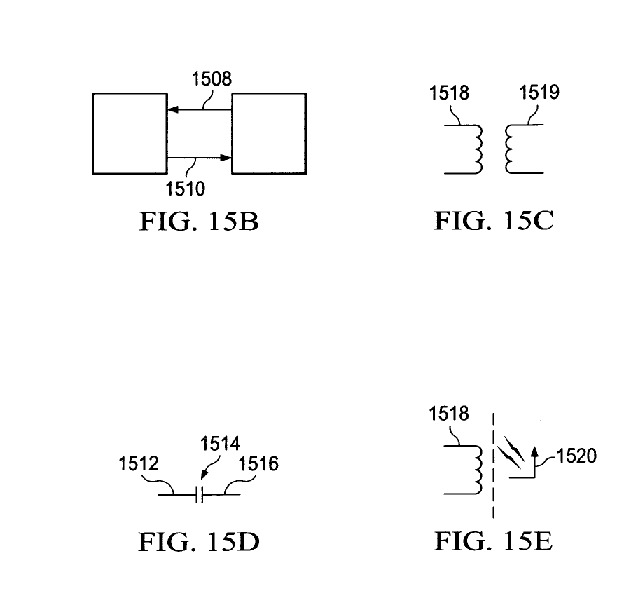

Referring to FIG. 15A ones observes a power/data interface shown at block 1504, which power/data interface is configured to couple power/data between block 1502, which may be a swing detector 200 or 400, and block 1506, which may be unit 500 or 600 as previously described. This power/data interface 1504 may be implemented by various means depending on the embodiment. Power may be provided by either direct physical contact as illustrated by FIG. 15B, or by proximal location as shown in FIGS. 15C, 15D, and 15E.

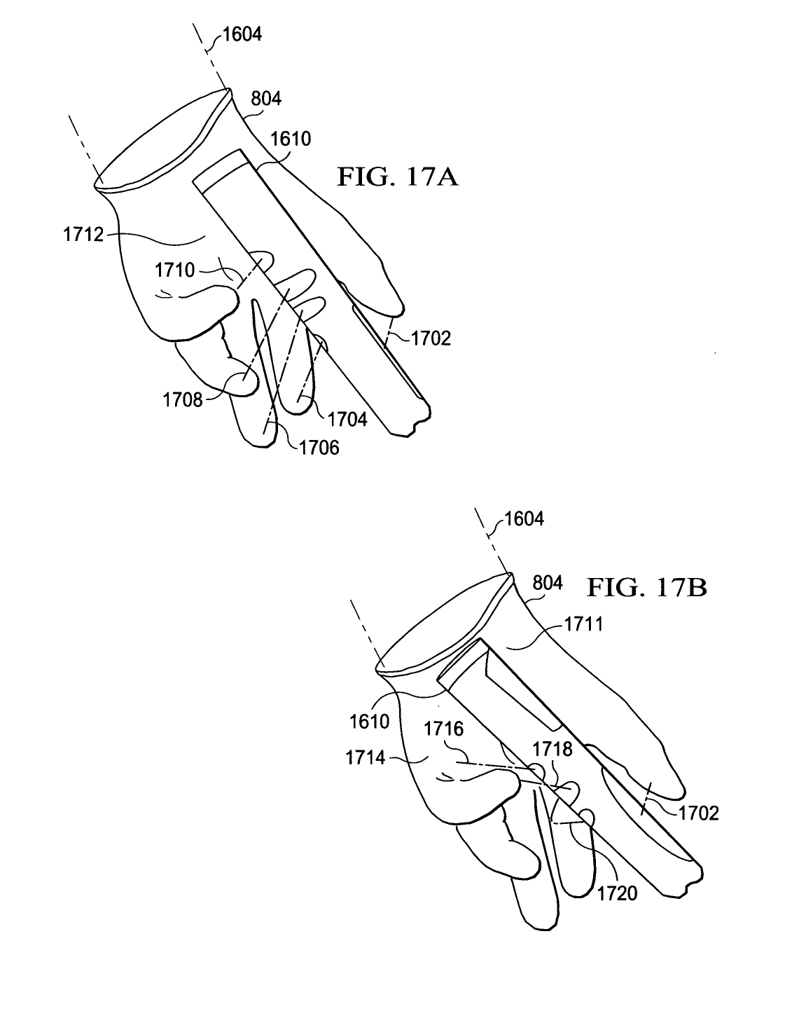

In one embodiment power is transferred from swing detector 200 or 400 by direct contact as shown in FIG. 15B. Here positive voltage and return conduction paths are shown at 1508 and 1510, respectively. In this embodiment these conduction paths may be implemented in the golf glove 804 and configured to transfer power to a club grip 1610 when brought into contact therewith. In this embodiment, paths 1508 and 1510 could directly relate to the mappings as shown at 1702 and 1712 shown in FIGS. 17A, and 17B, which will be described in more detail shortly.

Power may also be transferred from swing detector 200 or 400 to unit 500 or 600 without direct physical contact such as using inductive coupling as shown in FIG. 15C, capacitive coupling shown in FIG. 15D, or power derived from an RFID field shown in FIG. 15E, and discussed further in reference to FIG. 24.

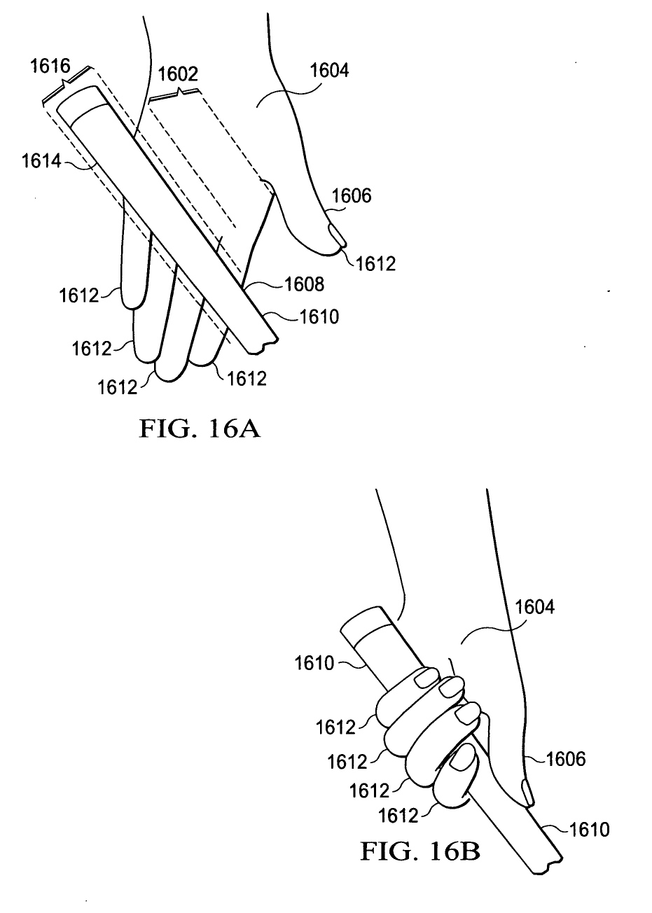

In FIG. 16A, the club grip 1610 contacts the hand at various locations in the region indicated at 1616. In FIG. 16B, the hand 1604 is shown closed about the club grip 1610 and providing a positive physical contact between fingers 1612, the area of the hand indicated at 1602 and 1616, and the club grip 1610.

FIG. 16B shows in a similar manner positive physical contact between the thumb 1606, the grip at 1610, and also the area of the hand palm hand indicated by 1602 and grip 1610 in the region of 1616.

FIG. 17A shows a perspective view of the hand 1604 configured to grasp club grip 1610, with the mapping of specific regions on the hand 1604 and fingers 1612 to corresponding electrically conductive contact points on grip 1610. A similar relationship is shown in FIG. 17B. Here, however, golf club grip 1610 is rotated slightly to expose hidden electrical contact points, and also highlight how a contact point on grip 1610 may vary in shape to better meet with the desired areas of contact and the direction the fingers take when gripping the club.

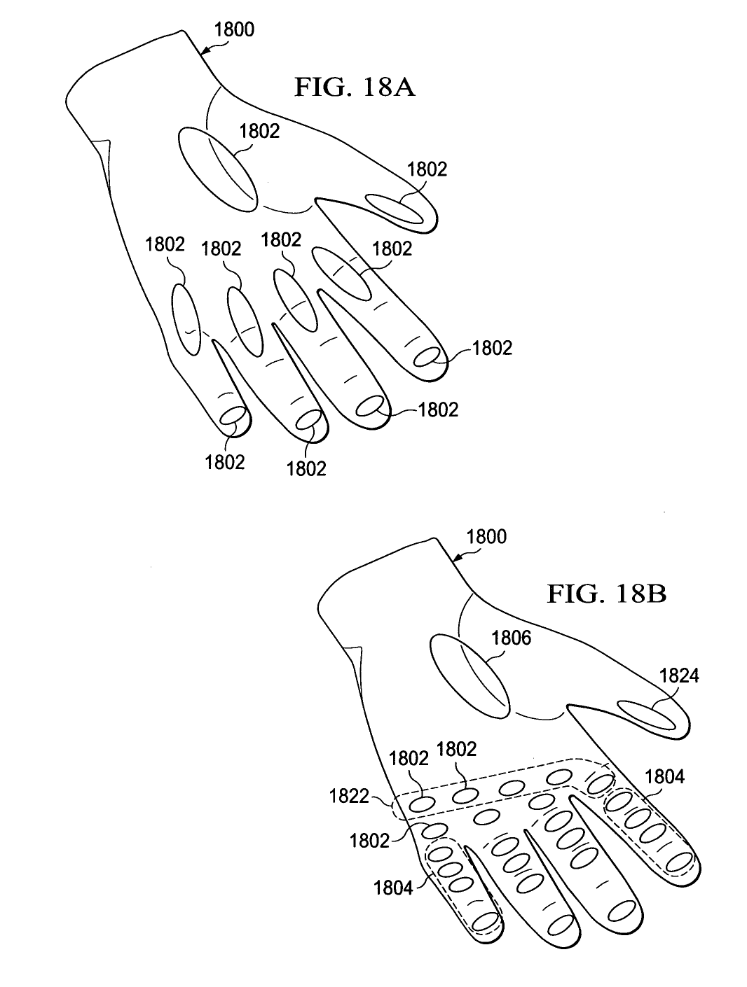

To avoid confusion it is understood that even though FIGS. 16A and 16B show the mapping between a golfer's hand 1604 and club grip 1610, electrical conductivity as taught herein is between the golf glove and the golf grip as shown in FIGS. 17A and 17B, FIGS. 18A and 18B, and also shown in FIG. 8 and worn by a golfer in FIG. 3. Additionally, for left-handed golfers the hand and grip may be reversed as appropriate.

Referring again to FIG. 17A one can see a direct correspondence between specific contact points on club grip 1610 and the fingertips of the golfer's fingers 1612, such as shown at 1702, 1704, 1706, 1708, and 1710; numbered from the thumb to the pinky, respectively. In this view, however, the grip contact 1711 as seen in FIG. 17B, corresponding to the point on the palm at 1712, cannot be seen.

In the same manner FIG. 17B shows the direct correspondence between specific contact points 1714, 1716, 1718, and 1720 on the golfer's hand, respectively, from the base of the pinky at 1714 to the base of the index finger at 1720 and the club grip. Shown also is the correspondence between the hand at the base of each finger in the region 1616 shown in FIG. 16A as opposed to the finger tip mapping in FIG. 17A. In this view, however, the grip contact 1711 as seen in FIG. 17B, corresponding to the point on the palm noted as 1712 in FIG. 17A cannot be seen.

The distinction of the contact point mappings specifically noted in FIG. 17A and 17B, between the golfer's glove and those on the golf club grip, will be further appreciated in a discussion of FIGS. 18A and 18B, as well as the discussions on the preferred embodiments.

FIG. 18A depicts the golf glove of FIG. 17A and FIG. 17B shown open, palm facing up. The electrical contact points of the physical zones on the glove indicated at 1802 are configured to transfer power and/or data information through physical proximity or physical contact with the club grip.

For instance, electrically conductive portions 1802 may be situated proximate the palm of the glove, the fingers proximate the palm, on the finger tips, or the thumb tip as desired for the selected embodiment. Some of these portions may also provide redundant paths for power or a circuit to make sure a suitable electrical path is established when used. These electrically conductive portions may be electrically coupled to a processing unit, such as a processing unit (not shown) that can be attached to the top of the glove or proximate a wrist portion of the glove, or even wirelessly relayed to remote processing unit, such as located at a golf cart.

FIG. 18B shows another representation of the golf glove 1800 with alternate arrangements of the physical electrical contacts 1802 used to enable various embodiments. In this embodiment, the plurality of conductive contacts 1802 are arranged in zones, such as one zone of contacts 1804 for each finger of the glove. The palm area of the hand indicated at 1602 in FIG. 16A is configured to be proximate and align with the linearly arranged electrical contact portion 1806 of the glove when worn, and a thumb contact is generally shown at 1824.

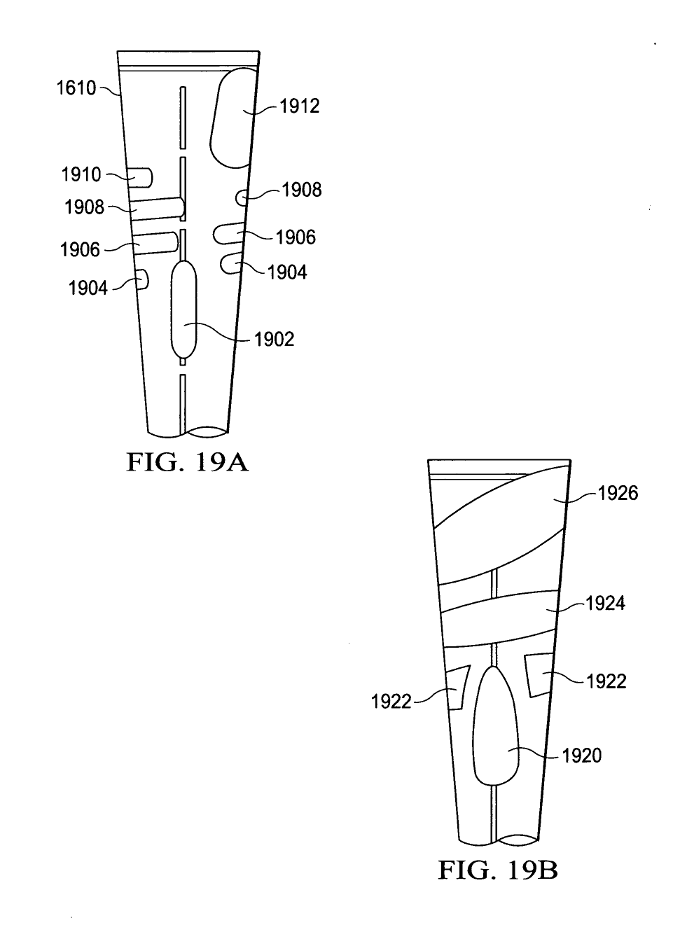

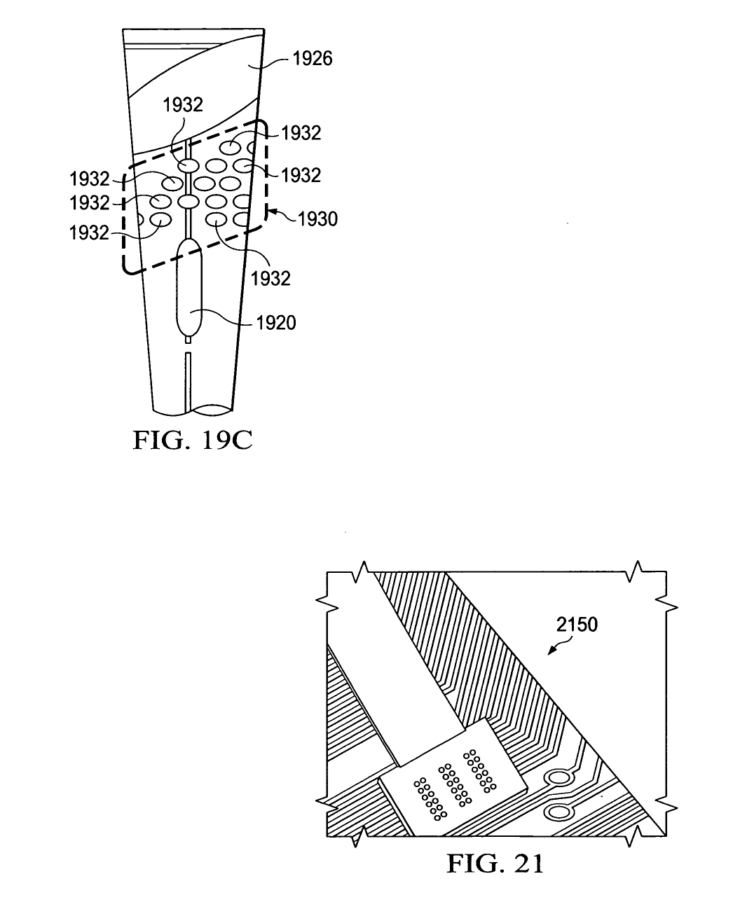

FIG. 19A depicts the golf club grip 1610 removed from a club, longitudinally split and laid flat. Physical zones of the electrical contacts on the club grip are configured to transfer information and/or power through physical proximity to, or in physical contact with, glove 1800. Here, it is clearly seen that physical contact between an elongated vertical conductive contact 1902 is configured to align with the thumb contact 1824 of glove 1800 as shown in FIG. 18B when properly gripping the grip. Likewise, a laterally extending contact 1904 is configured to align with the zone of contact(s) 1804 of the index finger sleeve of the glove. A laterally extending contact 1906 is configured to align with the zone of contact(s) 1804 of middle finger sleeve of the glove, a laterally extending conductive contact 1908 for the zone of contact(s) 1804 of the ring finger sleeve, and a laterally extending contact 1910 for the pinky finger zone of contact(s) 1804. A palm contact 1912 is configured to align with the palm pad 1806 of the glove.

FIGS. 19B and 19C show alternate representations of club grips used in various embodiments of this invention. The electrical contact pads each have a size and shape configured to provide for electrical contact with one or more of the glove contacts 1802. For instance, one of the laterally extending contact pads 1922, 1924, 1926 may have a wider width such that one or more of the grip contacts 1802 may electrically couple thereto. The number and size of the contact pads are chosen depending on how many electrical data signals may be desired, the amount of power to be delivered, the reliability of the contacts, and the tolerance established to ensure contact when the golfer's hand is shifted or oriented.

This set of electrical contacts may be used by a controller coupled to the contacts (not shown) to help determine that the club grip is properly oriented in the glove when gripped. For instance, referring to FIG. 18B, if contact with 3 or more of the contacts of portion 1822 are made with grip contacts 1922, 1924, 1926 shown in FIG. 19B then it is established that the golfer is correctly holding the club during a ball strike. FIG. 19C shows how the grip may have a plurality of electrical contacts arranged in zones 1930. The grip contacts 1932 can be designed and arranged to allow for the hand placement detection to be tolerant of position or extremely rigid. Basically, the contacts 1932 may be configured to map to the various contacts 1802 of glove 1800. For instance, each contact 1932 in the zone 1930 may detect individual or multiple points in glove zone 1822 as well as other contact zones like 1804. Additionally, as a training aid this can be made programmable so that a beginner selects a easy grip and a player advances in skill the detection of proper and repeatable grip can become more specifically required. It is understood that various arrangements of contacts may be configured for the purpose of detecting proper and repeatable hand grip positioning, and/or to insure contact and isolation between other signal interface paths. Moreover, the electrical contact points of the glove and/or the club grip may be non-planer, and raised/protruding to further enhance establishing a reliable electrically conductive connection when interfaced in use.

Additionally, it is understood that even though the teachings shown herein are only showing a single golf glove, a player may wear a second glove used with a club configured to perform the same functions as previously described.

Many materials normally do not conduct power or electrical signals, such as a leather golf glove. According to one aspect of the present invention, the golf glove's electrically conductive portions 1802 may be implemented using stitching or embroidering with electrically conductive thread, using electrically conductive cloth, or adhering to the glove an electrically conductive patch. Depending on the method chosen, resistance to electrical current conducting there through varies. Therefore, the size of the glove contacts 1802 is established to provide for suitable power transfer.

Referring now to FIG. 24 there is shown a wireless embodiment, as depicted in FIG. 15E, where power and/or data is interfaced and coupled between a remote unit, such as processing unit 806 or 822, and a golf club sensor module 2002 using RF energy. An RFID interface 2402 is provided which couples power from RFID device 2404 wirelessly to RFID device 2410 incorporated into a golf club. RFID transceiver 2410 is further configured to supply power to processing unit 2416 if employed, as well as the club sensor(s) 200.

Relevant swing data and club parameters are obtained from sensor(s) 200 and/or transferred from registers 2414 to registers 2412. Data is then communicated via RF between register 2412 and register 2406. All data can be unidirectional or bidirectional. Additionally, batteries may also be employed on the golf club to power the sensors and/or microcontroller.

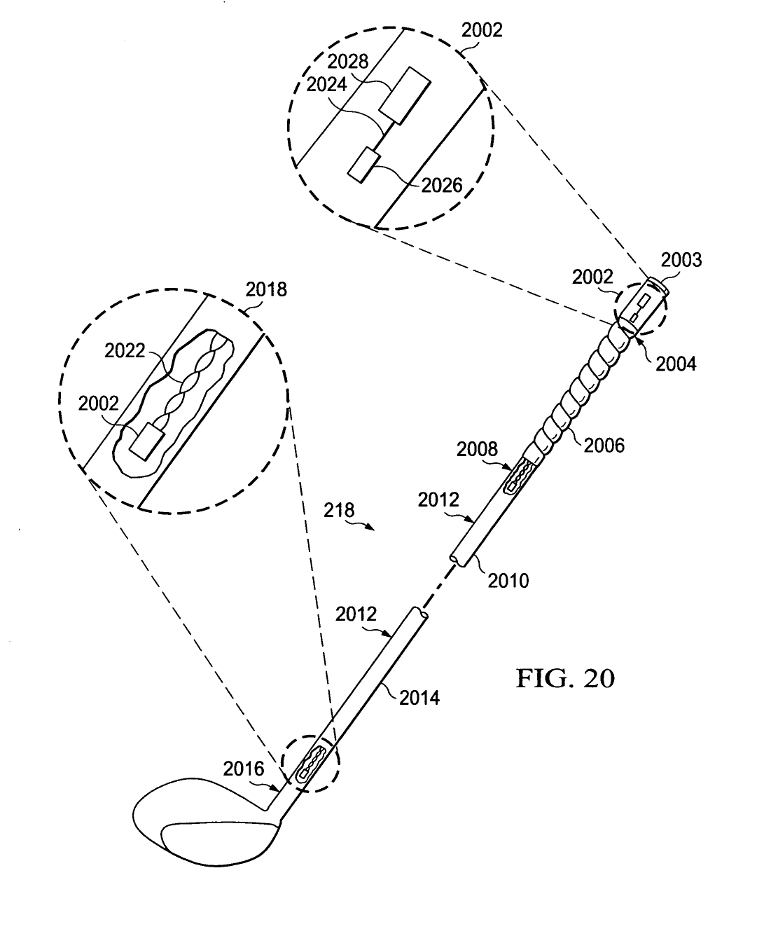

FIG. 20 shows possible locations on the golf club 218 that may be used for the sensor, processor, power, or antenna. It is understood that while FIG. 20 is illustrated as a driver for purposes of discussion, the present invention in its various embodiments may be used on any typical golf club such as those shown in FIGS. 2A, 2B, and 2C, or other variations not shown, such as a sand wedge or pitching wedge.

In FIG. 20 a driver 218 is shown with its shaft 2012 shown split into an upper section 2010 and lower section 2014. A module 2002 is shown securely affixed to shaft 2010 above grip 2006, and may be configured to be inserted into the end of the club. This module 2002 may be a part of a plastic or rubber shaft cap 2003, or a modular unit as will further be described.

Location 2004 indicates the location where a sensor, such as detector 200, or other device may be placed for such purposes as, but not limited to, swing detection, ball strike detection, golf club identification, and power or information transfer.

A module 2002, which may also be a detector 200, is shown that may be located at such locations indicated by 2004, 2008, or 2016. As shown here, this module 2002 may consist of a processing unit 2028, a sensor 2026, and a means for interconnecting these devices 2024. This module may be of such type as unit 400 or unit 500.

As fore mentioned keeping power consumption of a sensor module(s) low is advantageous. This may be accomplished by different means. One embodiment further configures module 2002 with a proximity sensor, not shown. This may be in the form of a sensor activated by a small magnet integrated into a golf glove. Another embodiment provides for activation by the physical contact between the grip and the golf glove, while another proximal activation is a result of the RF field generated by a proximal RFID device

At location 2008, a cutout reveals an electrical connection that may exist between a sensor, such as a microphone, and another device, such as module 2002. As shown, this may be simply twisted pair wire, or flexible circuitry such as that shown in FIG. 21 which may allow for communication between multiple components, including active or passive sensors, and the microcontroller.

FIG. 21 depicts one embodiment of a flexible circuit 2150 that may be embedded into, onto, or under the club grip 2008. Flexible circuits, which are commonly known in the art, allow it to conform to the shape of the golf shaft, allowing it to be placed under the grip itself, inside the club, or along the surface of the club if desired.

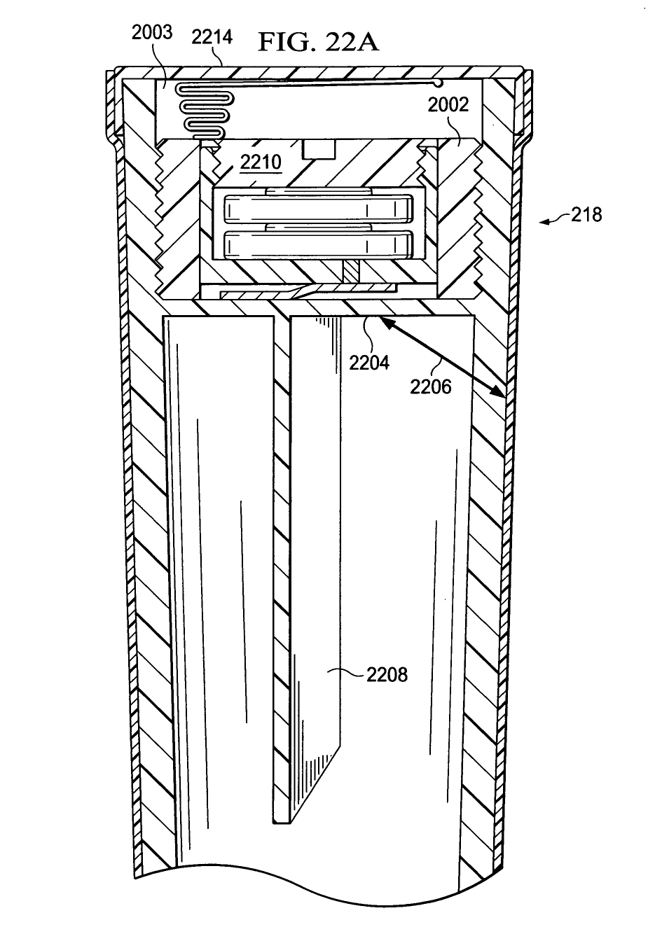

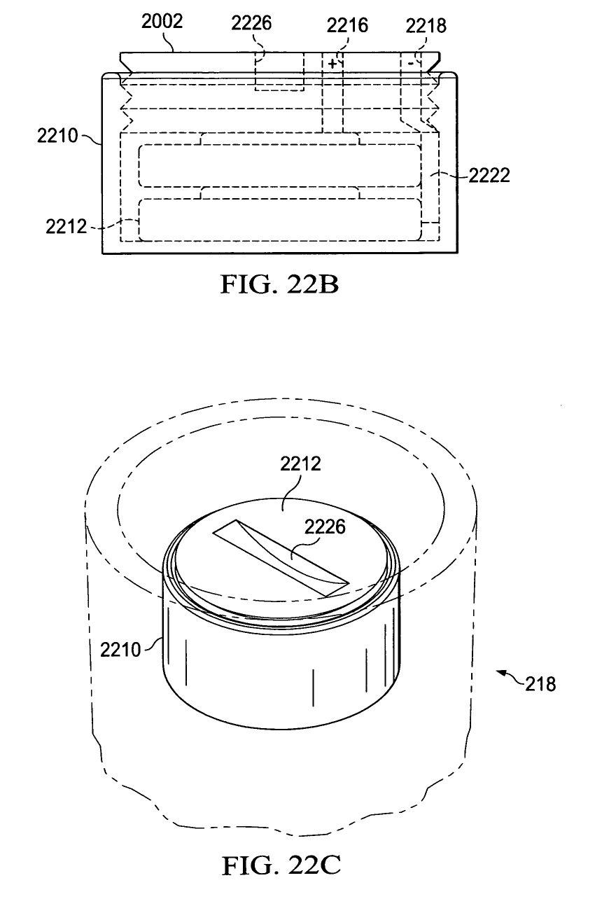

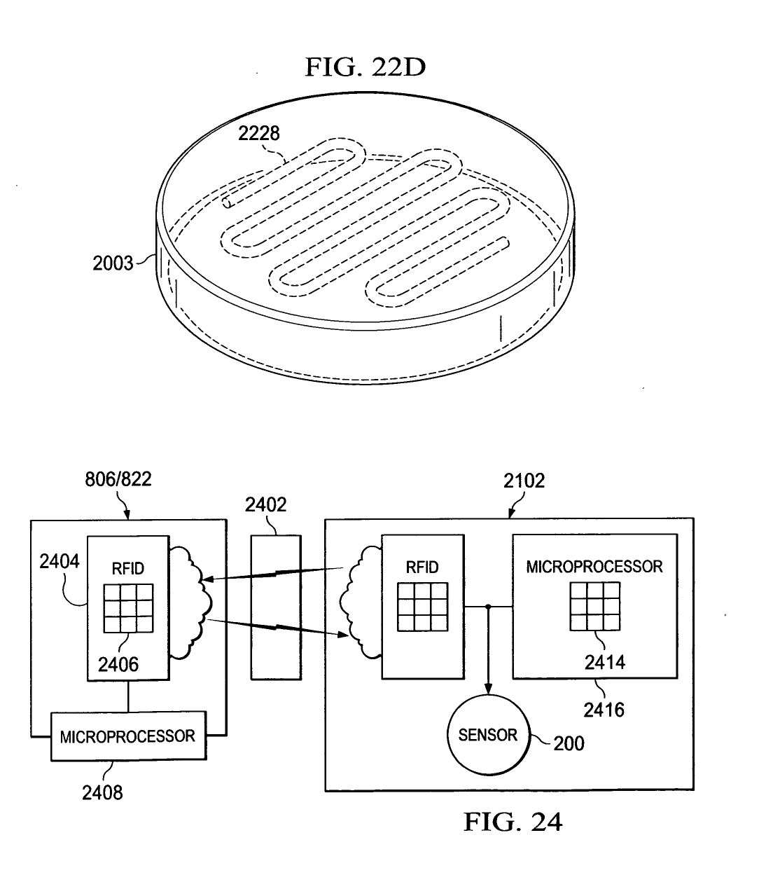

One preferred embodiment is the integration of the sensors in a golf club during manufacturing, while an additional embodiment provides for the sensor(s) to be retrofitted into a club by a user or dealer. FIG. 22A shows an embodiment in which a module, such as 2002, may be inserted into the top of the golf club 218.

The module 2002 may contain a sub module 2210 configured to contain a battery(s) 2212 that is accessible for replacement as shown in FIG. 22B. This battery may provide power to the sensors and/or electronics, such as the microcontroller. Access to the battery may be provided by unscrewing sub module 2210 aided by slot 2226 as shown in FIG. 22C, freeing sub module 2210 by the release of a pressure retention spring clip 2214 shown in FIG. 22A, or other means.

While access to the battery may be required in some instances it may also be desirable to charge the batteries in place. FIG. 22B shows an embodiment where electrical contact can be made with the battery externally to charge the batteries without removal. For example, electrical contact 2216 extends from the exterior to the positive electrode of the battery for providing a positive voltage thereto, and electrical contact at 2218 may be used to supply a ground return path for that voltage.

Another embodiment, as also shown in FIG. 22B, provides for a contact 2222 which completes a ground return along the entire length of metal shaft of the golf club 218.

In another embodiment the battery is replaced with a super capacitor or other means of energy storage. In this embodiment sub module 2210 does not need to be accessible. As with a battery the charging of a super capacitor may be accomplished by physical electrical contact between the charging power source and the super capacitor, or by a non physical means such as inductive, capacitive, or RF power coupling.

In FIG. 24D an embodiment is shown in which the signal interface coupling for module 2002 is enhanced by an antenna 2228 placed in the grip cap 2003 providing for improved signal strength.

To gain final perspective on the ability to retrofit a golf club, one should observe that a sub component of module 2002 is cap 2003. When it is desired to add a module, such as module 2002, to a previously non-equipped golf club one can remove the original cap if provided, or gain an access through the club grip, for example by drilling an appropriately sized hole. Module 2002 can then be inserted and held securely by pressure fit, glue adhesion, or some other means.

Due to the many embodiments enabled by this invention it is understood that a module 2002 may contain only one sensor such as a microphone or RFID device, may additionally be configured with a processing unit, may only serve to provide a power or signal interface to a sensor 200 located elsewhere within or on the golf club, or to interface with an external appliance.

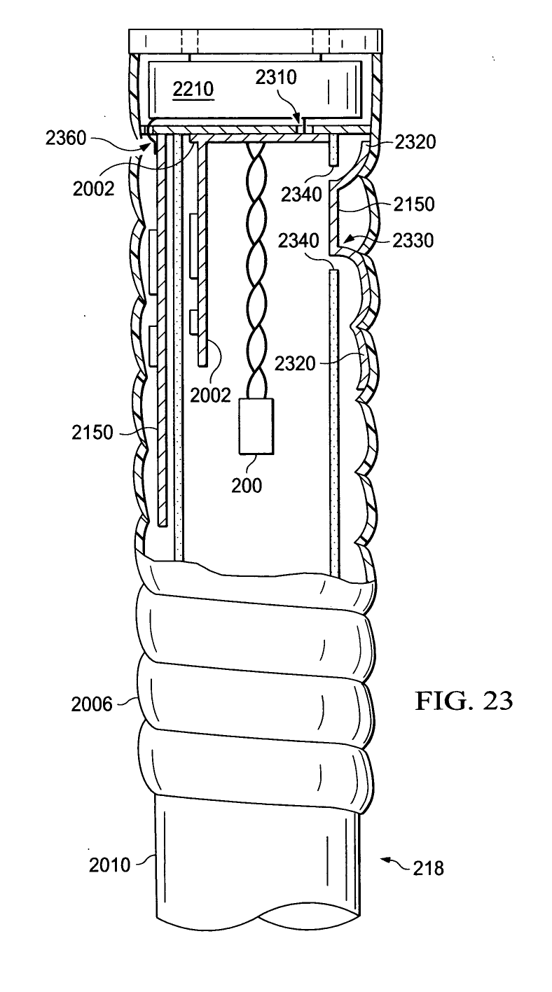

Looking at FIG. 23 the sensor module(s) 2002 are provided for and shown in several configurations. The sensor module(s) as seen in FIG. 23 may be internal to the golf club 218 orientated perpendicular to or parallel to club shaft 2010 and configured to couple the signals/power for the module to the top of the club shaft as shown at 2310 coupled to a sub module 2210.

When sensor module 2002 is located within the shaft of club 218 it may also be configured to couple the signals/power for the module 2002 to contacts 2320 on or within grip 2006 by way of a slot 2340 in the shaft itself. An internally mounted sensor module 2002 may also pass an antenna through the slot the 2340 which is wrapped around the shaft under the golf club grip thereby providing for a stronger signal transmission.

It is understood that in these internal configurations the circuit may be of rigid printed circuit board construction or a flexible circuit 2150. When a slot is cut into the club shaft the shaft may be produced with a thicker wall construction during manufacture at this location to aid in its strength. Additionally, a slot may also be entirely below the top edge of the club shaft as shown in FIG. 23, or extend completely to the top edge as may be desired in one embodiment of a retrofit module 2002. In such an embodiment the module 2002 may be potted or encapsulated using suitable material providing for additional strengthening of the area around the slot if desired.

In a different embodiment shown in FIG. 23 a flexible circuit 2150 is provided for the sensor module 2002 and located within or under the club grip 2006, configured such that electrical conductive paths provide for connection to the top of the club such as at location 2360 and/or to conductive contact points 2320 on or within the grip itself.

Also shown in FIG. 23 is a sensor(s) 200 which may be used alone or in conjunction with a sensor module 2002. As previously described signals/power to and from this sensor(s) may be configured to connect to the top of the club as shown at location 2310, with or without an intervening circuit 2002, or via a slot as shown at location 2330 to contact points 2320 on the club grip 2006.

Herein, the majority of signal and power couplings that have been described around sensor module 2002, are located at the top of a golf club proximal the grip and/or cap 2003. It is well understood that for various reasons module 2002, or a similar module, could be located anywhere within or on the club.

For example, module 2002 may located proximal the hosel at location 2016 shown in FIG. 20, and which may provide for greater sensitivity in swing arc, vibration analysis, acoustic analysis, etc. Additionally the teachings herein are not limited to a single module.

Although for purposes of descriptions of the internal to external signals of power coupling, it is understood that a sensor module need not be located 2004.

### First Embodiment

Accordingly to a first embodiment, a swing detection device, such as an accelerometer and processor may be coupled to each golf club in a set of clubs. The user wears a game module configured to communicate and process data from the swing detector during an actual golf shot. A game module includes software, as well as a GPS unit, whereby the accelerometer data as well as the club used can be stored as a function of the golfer location provided by the GPS unit, including hole information and golf course information. The accelerometer can detect the shock of a ball strike, wherein the computer module is configured to use this data to distinguish an actual ball hit from a divot. Automatic scoring can be provided along with GPS location coordinates and the golf club used. The computer module may include a micro display.

### Second Embodiment

Accordingly to a second embodiment, a swing detection device, such as an accelerometer and processor may be incorporated into a glove or as a wrist device. Each golf club is uniquely identified utilizing a device such as an RFID tag that may be passive or active as desired. In this embodiment the game module would excite the RF tag while in close proximity to it to determine the club used. Upon the event in which a player may switch clubs the processing of data would allow for correctly identifying which club was actually used last when the ball was struck. A game module includes software, as well as a GPS unit, whereby the accelerometer data as well as the club used can be stored as a function of the golfer location provided by the GPS unit, including hole information and golf course information. The accelerometer can detect the shock of a ball strike, wherein the computer module is configured to use this data to distinguish an actual ball hit from a divot. Automatic scoring can be provided along with GPS location coordinates and the golf club used. The computer module may include a micro display.

### Third Embodiment

Accordingly to a third embodiment, a swing detection device, such as an accelerometer and processor unit may be coupled to each golf club in a set of clubs. The user wears a communication module configured to communicate and process data from the swing detector during an actual golf shot. A separate module includes software, as well as a GPS unit. This module may be a unit such as a properly configured GPS unit located in a golf cart. Additionally this unit may be a simple PDF type device or cell phone wherein simplified performance data can be collected and stored for real time or post analysis.

### Four Embodiment

Accordingly to a fourth embodiment, a simplified shock detection device along with and modified RFID sensor may be utilized. In this embodiment a game module with query the sensor. The capability would be such that a stroke would be counted for a sufficient level of shock that results from a club striking a golf ball. The game module would have the capability to determine that a shot was performed, recorded the golf club used, and reset the shock detection device.

### Fifth Embodiment

Accordingly to a fifth embodiment, the user wears a swing detection device configured to communicate and process data from the swing detector during an actual golf shot. The data obtained from this device provides additional analysis information when coupled to an embodiment one, two, or three.

### Sixth Embodiment

According to a sixth embodiment, a user wears a golfing glove configured to communicate with a sensor, such as a microphone, contained within or on a golf club. The received signals from the sensor may be used to provide information during a club swing that a golf ball was struck, or determine that the event occurred. Upon analysis, determination can be made to increment the total shots taken during a golf game.

### Seventh Embodiment

According to a seventh embodiment, a user wears a golfing glove that is configured to communicate by physical proximity with a sensor, such as an RFID, contained within or on a golf club and providing a unique identification the club.

### Eight Embodiment

According to an eighth embodiment, a user wears a golfing glove that is configured to couple power by physical or proximal contact with a sensor contained within or on a golf club.

### Ninth Embodiment

Accordingly to a ninth embodiment, a sensor/processing module is configured to be coupled to a golf club, the module configured to ascertain a golf parameter indicative of an actual golf shot during game play on a golf course, the module having an interface configured to communicate a signal indicative of the parameter to a golf appliance physically remote from the golf club, such as the game module(s) described in embodiment 1 and 2 or the communication module described in embodiment 3.

### Tenth Embodiment

Accordingly to a tenth embodiment, a module is provided for which allows the coupling of power and signals across an interface proximal the golf club grip.

### Eleventh Embodiment

According to an eleventh embodiment, a user wears a golfing glove that is configured to detect proper hand positioning while in contact with sensor(s) contained within or on a golf club grip.

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

TABLE 1
Profiles Summary

| PROFILES | GPS | Accelerometer | Club mounted sensor |
|---|---|---|---|
| Ball Strike | | | |
| 1. Time/club profile | Req'r | | Any Club used sensor |
| delta | | | |
| 2. Momentum | | Req'r | |
| transfer | | | |
| 3. Swing angle delta | | Req'r | |
| 4. Sound pattern | | | Microphone |
| determination | | | |
| Club Used | | | |
| 1. RFID read | | | RFID Tag |
| 2. RF transfer | | | Accelerometer or |
| | | | microphone |
| 3. Grip transfer | | | Resistive or microphone |
| Club swing | | | |
| 1. Backswing | | Req'r | Club used or accelerometer |
| 2. Follow-through | | Req'r | Club used or accelerometer |
| 3. Aim alignment | | Req'r | Club used or accelerometer |
| 4. Swing angle | | Req'r | Club used or accelerometer |
| Accelerometer | | | |
| 1. Vibration | | Req'r | Club used or accelerometer |
| 2. Directional plane | | Req'r | Club used or accelerometer |
| 3. Swing angle | | Req'r | Club used or accelerometer |
| Traveling | | | |

| | |
|---|---|
| 1. Riding | Each of these profiles is dependent on these |
| 2. Walking | sensor combinations chosen above. The |
| 3. Waiting | requirements will be described in detail in |
| 4. Watching | the various embodiments. |

TABLE 2
Devices Summary

| Device | Purpose | Location | Used with |
|---|---|---|---|
| Scoring display | The basic purpose of this | This device may be | One embodiment requires only a ball strike |
| device | device is to automatically keep | located on a golf cart, | detector to automatically count strokes. |
| | one's golf score. Dependent on | worn like a watch, | Additional embodiments incorporate or |
| | the embodiment and the other | integrated into a golf | integrate a swing detector. By adding a club |
| | devices utilized, this device can | glove, clipped onto ones | ID means and GPS receiver a golfer can |
| | range from automatically | belt, or be an application | easily analyze how he has performed |
| | counting the shots to providing | within a PDA or cell | throughout play on a particular course using |
| | the data for a complete swing | phone. | his various clubs. Additionally, various |
| | and body position analysis for | | sensors may be worn to provide information |
| | each swing and club used in | | on how his body position throughout the |
| | active play. | | swing affected each shots outcome. An |
| | | | example of such a sensor would be a head |
| | | | position sensor. |
| Swing detector | In one embodiment a profiling | This may be worn on the | The swing detector will need to be part of or |
| | algorithm is used to determine | wrist, be part of a golf | used with a scoring display device. When |
| | a swing and hit of a golf ball | glove, or integrated into | physically separate from the automatic |
| | has occurred. Another | each golf club. | scoring device a means such as IR, RF, or |
| | embodiment will capture swing | | Bluetooth communications providing for |
| | specific data used for later | | the transfer of data to the scoring device |
| | analysis for improving one's | | must be incorporated. When used in |
| | game. | | embodiments providing play analysis a |
| | | | means for obtaining the club ID information |
| | | | must incorporated. |
| Ball strike | In one embodiment no | The ball strike detector | A means to convey this information directly |
| detector | information is provided about | will be located within each | or indirectly to the automatic scorer display |
| | the swing itself, only that a golf | golf club | device must be provided for. |
| | ball was hit. Another | | |
| | embodiment may choose to | | |
| | incorporate this detector along | | |
| | with the swing detector. | | |
| Club ID | In order to provide meaningful | In all embodiments the | A means to convey the club used |
| | analysis, information | device that provides this | information must be provided for between |
| | identifying what club was used | identification must be | each golf club and either the swing detector |
| | during each swing, and where | physically attached to | or the automatic scoring device. |
| | the ball landed as a result of | each golf club. | |
| | that swing is required. | | |
| GPS receiver | Provides information on the | Must be physically worn | This will always be used with some |
| | location of the golfer | by the golfer. | combination of the above mentioned |
| | throughout the game play. For | | devices. |
| | play analysis the GPS receiver | | |
| | specifically records where each | | |
| | shot was taken from relative to | | |
| | the hole. This information is | | |
| | also used to produce the cause | | |
| | effect analysis of each shot on a | | |
| | specific golf course, each time | | |
| | the golfer hits a ball. | | |
| Body positions | This section to be completed | | |
| sensors | later. | | |

TABLE 3
Method Overview

| Profile Provided For | Devices Used | Method Description |
|---|---|---|
| Ball Strike | | |
| 1. Time/club profile | Scoring display unit with | As a golfer grips a club an event profiling starts |
| delta | integrated GPS, and RFID | that determines the time the club is held, what |
| | reader. RFID tagged | club it is, time elapsed between different club |
| | clubs. | handling, and GPS location changes; with and |
| | | without a club handling. |
| 2. Momentum | Scoring display unit with | X, Y, Z, axis accelerometer provides information |
| transfer | integrated club swing | to a microprocessor that determines a step |
| | detector. | function delta has occurred that is characteristic |
| | | of a golf ball hit. |
| 3. Swing angle | Scoring display unit with | X, Y, Z, axis accelerometer provides information |
| delta | integrated club swing | to a microprocessor that determines a club has |
| | detector. | been swung showing an angle profile change |
| | | along one or more axis determined to indicate a |
| | | club swing. |
| 4. Sound pattern | Scoring display unit. Golf | The microphone internal and near the head of a |
| determination | clubs with ball strike | golf club profiles a sound pattern indicating the |
| | microphone sensor and | golf ball strike. Stroke count information is |
| | RF transceiver, or direct | transferred to the scoring unit by low power RF |
| | grip contacts. | transceivers or direct grip. |
| Club Used | | |
| 1. RFID read | The scoring display unit | When a golf club is within close proximity, for |
| | (if worn by the golfer) or | example several inches to a scoring unit or |
| | swing detector is | swing detector this unit will excite the RF ID tag |
| | equipped with an RFID | providing club specific information. |
| | reader and RFID tagged | |
| | golf clubs. | |
| 2. RF transfer | RF transceivers | These units may be in several places, depending |
| | | on the application they be located in each golf |
| | | club, if equipped with accelerometers; in any |
| | | embodiment of a gaming unit, or in a body worn |
| | | swing detector. Depending on the embodiment |
| | | the communication may be taking place between |
| | | any of these devices. |
| 3. Grip transfer | Physical direct contact | For the purpose of identifying the golf club with |
| | between a specialized golf | the most typical embodiment being resistive |
| | glove and the club. | identification. |
| Club swing | | |
| 1. Backswing | Accelerometers either | Time and angle, or time and X, Y, Z |
| 2. Follow-through | club mounted or body | accelerometer axis information and calculations |
| 3. Aim alignment | worn by used in all of | are used or determining these profiles. |
| 4. Swing angle | these profiled events. | |
| Accelerometer | | |
| 1. Vibration | Accelerometers either | The accelerometers may be used to determine |
| 2. Directional plane | club mounted or body | that a swing has occurred, a ball has been struck, |
| 3. Swing angle | worn by used in all of | travel is occurring, or in the analysis of the |
| | these profiled events. | players swing. |
| Traveling | | |
| 1. Riding | Accelerometers either | For embodiments that do not employ a GPS |
| 2. Walking | club mounted or body | receiver, these profiles are used to determine the |
| 3. Waiting | worn bar used in all of | high probability that the golfer as taken a shot. |
| 4. Watching | these profiled events in | |
| | the embodiments that do | |
| | not employ a GPS | |
| | receiver. | |

1. A system, comprising:
a module configured to be coupled to a golf club, the module configured to ascertain a golf parameter during game play on a golf course, the module having an module interface configured to communicate a signal indicative of the parameter; and
a golf appliance having an appliance interface configured to receive the signal indicative of the golf parameter from the module.

2. The system as specified in claim 1 wherein the golf appliance is configured to be worn by a golfer.

3. The system as specified in claim 1 wherein the module includes a sensor.

4. The system as specified in claim 1 wherein the module interface is configured to communicate the signal when the golf appliance is in close proximity to the module.

5. The system as specified in claim 4 wherein the module is configured to detect when the golf appliance is in close proximity to the module and responsively communicate the signal to the golf appliance.

6. The system as specified in claim 1 wherein the module is configured to be coupled to the golf club proximate a grip of the golf club.

7. The system as specified in claim 1 wherein the golf parameter is indicative of the type of club.

8. The system as specified in claim 1 wherein the golf parameter is indicative of a swing of the golf club.

9. The system as specified in claim 8 wherein the golf parameter is indicative of the velocity of a swing of the golf club.

10. The system as specified in claim 8 wherein the golf parameter is indicative of the acceleration of the golf club.

11. The system as specified in claim 8 wherein the golf parameter is indicative of the de-acceleration of the golf club.

12. The system as specified in claim 8 wherein the golf parameter is indicative of the change in acceleration of the golf club.

13. The system as specified in claim 12 wherein the golf parameter is indicative of the direction of change in the acceleration of the golf club.

14. The system as specified in claim 1 wherein the golf parameter is indicative of a golf ball strike by the golf club.

15. The system as specified in claim 6 further including a golf club grip, wherein the module interface is integral to the grip.

16. The system as specified in claim 1 wherein the module is configured to receive power from the golf appliance across the interface.

17. The system as specified in claim 16 wherein the device is configured to transition from a reduced power state to a higher power state when the module is in close proximity to the golf appliance.

18. The system as specified in claim 1 wherein the module further comprises a battery configured to power the module.

19. The system as specified in claim 1 wherein the module further comprises an RFID device.

20. The system as specified in claim 19 wherein the RFID device is configured to couple the signal indicative of the golf parameter to the module interface.

21. The system as specified in claim 19 wherein the RFID device has an indicator indicative a type of golf club.

22. The system as specified in claim 2 wherein the golf appliance is a golf glove comprising at least one electrical contact configured to make an electrical path with a golf club grip when gripped.

23. The system as specified in claim 22 wherein the module interface comprises a club grip including a plurality of electrical contacts.

24. The system as specified in claim 1 wherein the module further comprises a processor configured to generate the signal.

25. The system as specified in claim 24 wherein the processor is configured to derive power from the golf appliance.

26. The system as specified in claim 24 wherein the module comprises an RFID device configured to couple the signal indicative of the parameter across the module interface to golf appliance.

27. The system as specified in claim 24 wherein the module further comprises a sensor configured to interface with the processor.

28. The system as specified in claim 24 wherein the module comprises an RFID device configured to couple the signal indicative of the parameter from the processor to the golf appliance.

29. The system as specified in claim 28 wherein the golf parameter is selected from the set comprising: a ball strike, swing velocity, club acceleration, club de-acceleration, and a change of direction of a club's acceleration.

30. The system as specified in claim 3 wherein the golf appliance is configured to couple power sufficient to power the sensor.

31. The system as specified in claim 3 wherein the sensor is configured to be disposed proximate a golf club hosel.

32. The system as specified in claim 3 wherein the sensor comprises an accelerometer.

33. The system as specified in claim 3 wherein the sensor comprises a microphone.

34. The system as specified in claim 2 wherein the golf appliance is a scoring system configured to process the signal.

35. The system as specified in claim 34 wherein the scoring system includes a display.
